(19) United States
(12) Patent Application Publication
(10) Pub. No.: US 2017/0105220 A1
(43) Pub. Date: Apr. 13, 2017

(54) WIRELESS COMMUNICATION DEVICE AND WIRELESS CONNECTION METHOD

(71) Applicant: KABUSHIKI KAISHA TOSHIBA, Minato-ku (JP)

(72) Inventors: Toshiyuki NAKANISHI, Yokohama (JP); Ryoko MATSUO, Shinagawa (JP); Toshihisa NABETANI, Kawasaki (JP); Hirokazu TANAKA, Bunkyo (JP)

(73) Assignee: KABUSHIKI KAISHA TOSHIBA, Minato-ku (JP)

(21) Appl. No.: 15/388,618

(22) Filed: Dec. 22, 2016

Related U.S. Application Data
(63) Continuation of application No. PCT/JP2015/070196, filed on Jul. 14, 2015.

(30) Foreign Application Priority Data
Jul. 14, 2014 (JP) 2014-144462

(51) Int. Cl. H04W 72/04; H04B 1/3827; H04W 4/00; H04W 76/02

(52) U.S. Cl. CPC H04W 72/0453; H04W 76/021; H04B 1/3833; H04W 4/008

(57) ABSTRACT

According to one embodiment, a wireless communication device includes: a first communicator configured to receive a first identification information when a distance from a first communication device becomes a first distance or shorter, the first identification information identifying another communication device; and a second communicator configured to receive a second identification information, the second identification information identifying the other communication device. The second communicator is configured to transmit a wireless signal in response to a result of comparison of the first identification information and the second identification information, the wireless signal being transmitted for connecting to a wireless network formed by either one of the device itself and the other communication device.

### CROSS REFERENCE TO RELATED APPLICATIONS

This application is a Continuation of International Application No. PCT/JP2015/070196, filed on Jul. 14, 2015, the entire contents of which is hereby incorporated by reference.

### FIELD

Embodiments of the present invention relate to a wireless communication device and a wireless communication method.

### BACKGROUND

In an environment where multiple wireless networks are present, when a node selects a destination hub from among multiple hubs, it is a known practice for the node to select the one that exhibits the highest reception signal intensity. When a node has a user interface such as a display device and an input device, it is also a known method to cause a list of hub IDs identifying individual hubs to be displayed on a screen so that the user is allowed to select a desired hub ID from the list.

In the method of selecting the hub exhibiting the highest reception signal intensity, however, the wireless communication terminal may be made to participate in a wireless network which is not the wireless network the user wants to make it participate in. Meanwhile, when a node does not incorporate any display device in consideration of downsizing of the node and low power consumption, it is not possible to draw on the method of selecting the desired hub ID from among those displayed on the screen.

### BRIEF DESCRIPTION OF THE DRAWINGS

FIG. 1 is a diagram illustrating a configuration of a communication system in accordance with a first embodiment;

FIG. 2 is a diagram illustrating a configuration of a hub 1 in accordance with the first embodiment;

FIG. 3 is a diagram illustrating a configuration of a node 2 in accordance with the first embodiment;

FIG. 4 is a diagram illustrating a configuration of an auxiliary terminal 3 in accordance with the first embodiment;

FIG. 5 is a diagram illustrating a flow of information in accordance with the first embodiment;

FIG. 6 is a diagram illustrating details of information exchanged among the hub 1, the auxiliary terminal 3, and the node 2 in accordance with the first embodiment;

FIG. 7 is a flowchart illustrating an example of a wireless connection method for the node 2 to be connected to a wireless network formed by the hub 1;

FIG. 8 is a table illustrating information to be transmitted in accordance with a second embodiment;

FIG. 9 is a flowchart illustrating an example of processing by the node 2 in a case where all pieces of additional information illustrated in FIG. 8 are transmitted to the node 2;

FIG. 10 is a diagram illustrating a configuration of the auxiliary terminal 3 in accordance with a third embodiment;

FIG. 11 is a diagram illustrating a flow of information in accordance with the third embodiment;

FIG. 12 is a table illustrating information to be transmitted in accordance with the third embodiment;

FIG. 13 is a flowchart illustrating an example of a wireless connection method for the node 2 to be connected to the wireless network formed by the hub 1;

FIG. 14 is a diagram illustrating a flow of information in accordance with a fourth embodiment;

FIG. 15 is a table illustrating information to be transmitted in accordance with the fourth embodiment;

FIG. 16 is a flowchart illustrating an example of a wireless connection method for the node 2 to be connected to the wireless network formed by the hub 1;

FIG. 17 is a diagram illustrating an example of a hardware configuration of a second communicator 14 of the hub 1 in accordance with the first embodiment;

FIG. 18 is a diagram illustrating an example of a hardware configuration of the second communicator 24 of the node 2 in accordance with the first embodiment;

FIG. 19A is a perspective view of a wireless communication terminal in accordance with a sixth embodiment;

FIG. 19B is a perspective view of another wireless communication terminal in accordance with the sixth embodiment; and

FIG. 20 is a diagram illustrating a memory card in accordance with the sixth embodiment.

### DETAILED DESCRIPTION

According to one embodiment, a wireless communication device includes: a first communicator configured to receive a first identification information when a distance from a first communication device becomes a first distance or shorter, the first identification information identifying another communication device; and a second communicator configured to receive a second identification information, the second identification information identifying the other communication device. The second communicator is configured to transmit a wireless signal in response to a result of comparison of the first identification information and the second identification information, the wireless signal being transmitted for connecting to a wireless network formed by either one of the device itself and the other communication device.

A communication device that is adapted to be mounted on an object and used in this state (e.g., a wearable terminal) has constraints such as its size and therefore, it is difficult to incorporate a user interface such as a display device and an input device in the communication device. When a wireless network is formed around or near an object, this object as such may act as a shielding object that hinders wireless communications. As a result, it may be the case that a hub exhibiting the highest reception signal intensity is in fact a hub forming a wireless network around or near another object. In this case, when the hub is selected only based on the reception signal intensity without using any user interface, a communication device mounted on an object may undesirably establish communication with a hub forming a wireless network around or near another object. In view of this, the embodiments achieve increase in the probability of the communication device participating in a wireless network the user wants to make the communication device participate in by configuring a communication system such that communication is established between a target object on which the communication device is mounted and the hub mounted on the same target object.

A wireless connection method for establishing a connection to a wireless network formed around or near an object is described in the context of the individual embodiments. Here, the “object” as used herein includes a biological object such as an animal (including a human body) and a plant, an object that is not a biological object (e.g., an automobile), and the like. Descriptions in accordance with the embodiments are provided in the context of a human body as an example of the object. Also, the descriptions in accordance with the embodiments are provided, by way of example, in the context of a body area network (BAN), which is a wireless network formed around or near the human body. The following describes the embodiments of the present invention with reference to the drawings.

The embodiments solve the same problem of improving the probability of participating in a desired wireless network. As another example, it is required that a time required to establish communication be short in a case where the device is used for emergency first aid purposes. Further, as biological sensing may result in different tendencies of the obtained biological signals depending upon the mounting position and direction of the sensor, it is important to identify the mounting position and direction or the like of the sensor. In addition, some types of sensing require time synchronization among multiple nodes or between a hub and a node. Finally, in an environment where numerous BANs are present, interference between BANs and interference between a BAN and any other wireless networks that is not a BAN may occur. Eliminating these interferences at the stage of establishing the connection is desirable in view of stability of communications. In view of these aspects, in accordance with the embodiments, at least one of the following problems is solved in addition to the above-described first problem.

The second problem to be addressed is to identify the mounting position and direction of the sensor. The third problem to be addressed is to ensure time synchronization between the hub and the node. The fourth problem to be addressed is to shorten the processing time required to establish communication. The fifth problem to be addressed is to reduce interference with another BAN or a wireless network that is not a BAN.

### First Embodiment

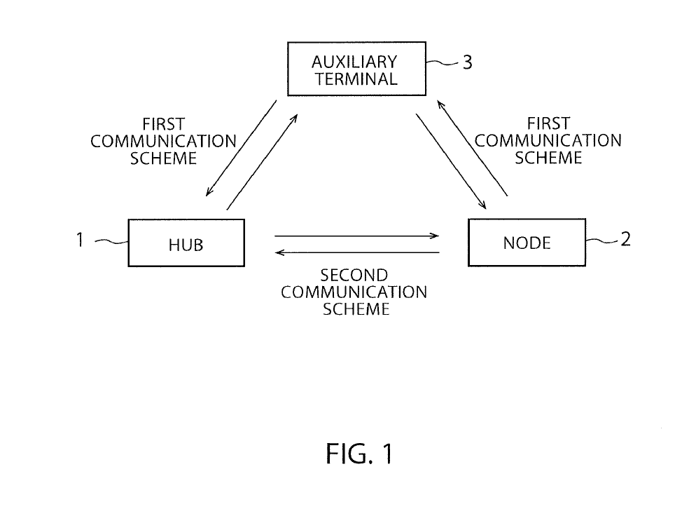

First, the first embodiment is described below. FIG. 1 is a diagram that illustrates a configuration of a communication system in accordance with the first embodiment. As illustrated in FIG. 1, the communication system in accordance with the first embodiment includes a hub 1 that forms a wireless network, a node 2, and an auxiliary terminal (auxiliary communication device) 3.

The hub 1 is a wireless communication terminal or communication device that carries out wireless communications with the auxiliary terminal 3 using a first communication scheme. Also, the hub 1 carries out wireless communications with the node 2 using a second communication scheme which is different from the first communication scheme.

The node 2 is a wireless communication terminal or communication device that carries out wireless communication with the auxiliary terminal 3 using the first communication scheme.

The auxiliary terminal 3 is used when the node 2 should be participated in the wireless network formed by the hub 1. The auxiliary terminal 3 is a portable terminal device.

Here, the “first communication scheme” as used herein is a short-range wireless communication scheme that becomes available when a distance from a communication partner falls within a certain distance range (i.e., becomes a certain distance or shorter). The distance range may be, or does not need to be, a predefined distance range (prescribed distance range) that is defined in advance by specific numerical values or the like. In the following, it is assumed that the distance range is given as the prescribed distance range, but the distance range does not need to be known. By virtue of this, wireless communications are made possible in the first communication scheme between the auxiliary terminal 3 and the communication partner by a user's action to hold the auxiliary terminal 3 toward or over the communication partner. In accordance with this embodiment, the first communication scheme is described as a short-range wireless communication scheme according to which, for example, communications are carried out while communication devices are brought into contact with each other, or the communication devices are placed in vicinity to each other in the order of several centimeters to one meter. It should be noted that this short-range wireless communication scheme is, by way of example, a scheme for near field communication (NFC), communications that rely on radio frequency identifiers (RFID), or TransferJET™.

The second communication scheme is a scheme in which a connection is made to a wireless network formed near an object and wireless communications are carried out after the connection is established. Here, the object includes a biological object including an animal (including a human body) and a plant, an object that is not a biological object (e.g., an automobile), and the like. Also, a wireless network formed around or near a human body is called body area network (BAN). In this second communication scheme, in contrast to the first communication scheme, it is difficult for a user to clearly recognize a communication partner.

The hub 1 and the node 2 in accordance with this embodiment are, for example, a wearable terminal which needs to have a small size, light weight, and low power consumption. Meanwhile, the auxiliary terminal 3 is, for example, a tablet terminal, multifunctional mobile phone (smartphone), or laptop PC whose requirements are less strict than those of the hub 1 and the node 2 described above. The auxiliary terminal 3 has, for example, a user interface such as a touch panel so that a user can input information and confirm the input information.

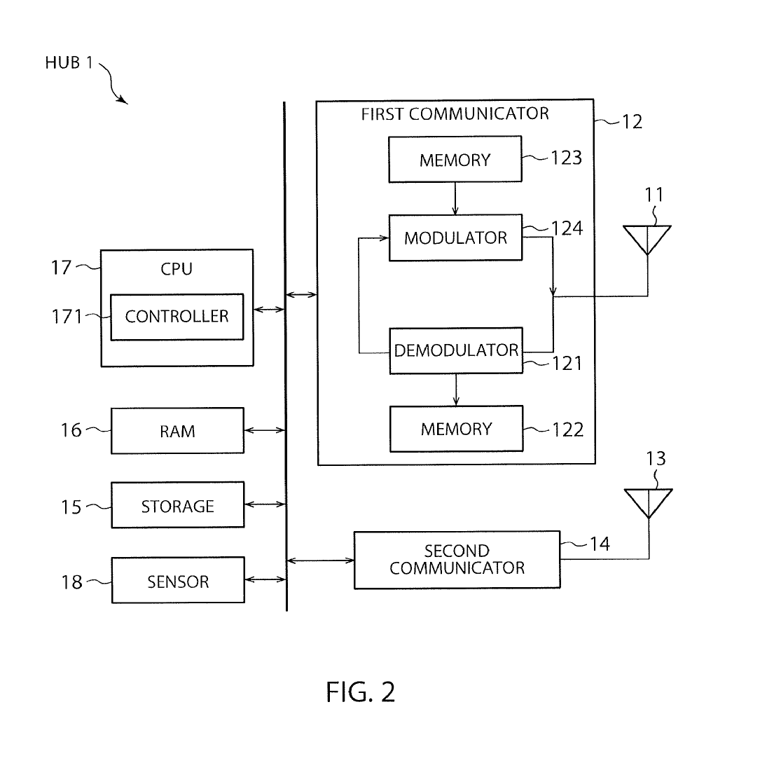

The configuration of the hub 1 is described below. FIG. 2 is a diagram that illustrates the configuration of the hub 1 in accordance with the first embodiment. As illustrated in FIG. 2, the hub 1 includes an antenna 11, a first communicator 12 connected to the antenna 11, an antenna 13, and a second communicator 14 connected to the antenna 13. Further, the hub 1 includes storage 15, RAM (Random Access Memory) 16, a CPU (Central Processing Unit) 17, and a sensor 18.

The first communicator 12, the second communicator 14, the storage 15, the RAM 16 and the CPU 17 are interconnected via a bus so that information can be transmitted among these components.

The first communicator 12 is configured to carry out communications with the auxiliary terminal 3 via the antenna 11 using the short-range wireless communication scheme. The first communicator 12 is, for example, a modem, and specifically, for example, a passive RFID chip. The first communicator 12 is a communication circuit and configured by way of example by an integrated circuit.

Here, the first communicator 12 includes a demodulator 121, memory 122, memory 123, and a modulator 124.

The demodulator 121 is configured to carry out demodulation of a reception signal that has been received via the antenna 11 from the auxiliary terminal 3 and store information wirelessly transmitted from the auxiliary terminal 3 in the memory 122.

A hub ID which is an example of a first identification information identifying the device itself, device identification information identifying the first communicator 12 (e.g., a MAC address, which is hereinafter referred to as “first piece of device identification information”) are stored in the memory 123. This device identification information is a unique value for each communicator (e.g., a modem).

It should be noted that the hub ID and the first piece of device identification information may be stored in the same memory unit.

The modulator 124 is configured to read the hub ID and the first piece of device identification information stored in the memory 123 and subject the hub ID and the first piece of device identification information that have been read to modulation. In addition, the modulator 124 wirelessly transmits a transmission signal obtained as a result of the modulation via the antenna 11.

The second communicator 14 is configured to carry out wireless communications with the node 2 via the antenna 13 using the second communication scheme which is different from the short-range wireless communication scheme. The second communicator 14 is a communication circuit and, by way of example, configured by an integrated circuit.

Programs for controlling individual components of the device itself are stored in the storage 15. Also, a hub ID which is an example of the second identification information identifying the device itself is stored in the storage 15. The storage 15 may be, for example, volatile memory such as SRAM and DRAM, non-volatile memory such as NAND and MRAM, a hard disk, or an SSD.

The random access memory (RAM) 16 is a volatile memory device that temporarily stores information.

The central processing unit (CPU) 17 reads programs from the storage 15 into the RAM 16 and executes these programs, and thus functions as the controller 171. The CPU 17 includes a control circuit that operates as the controller 171. The controller 171 is configured to control the second communicator 14. The wireless communication integrated circuit in accordance with this embodiment includes the CPU 17 or the controller 171, and may further include a communication circuit which is the first communicator 12 and another communication circuit which is the second communicator 14.

The sensor 18 is configured to measure information regarding an object (e.g., a human body) on which the device itself is mounted. For example, when the device itself is mounted on the human body, the sensor 18 measures biological information of the human body on which the device itself is mounted. Here, the biological information may include, but not limited to, body temperature, blood pressure, pulse wave, electrocardiography, heartbeat, blood oxygen level, urinal sugar, blood sugar, body motion, and body direction.

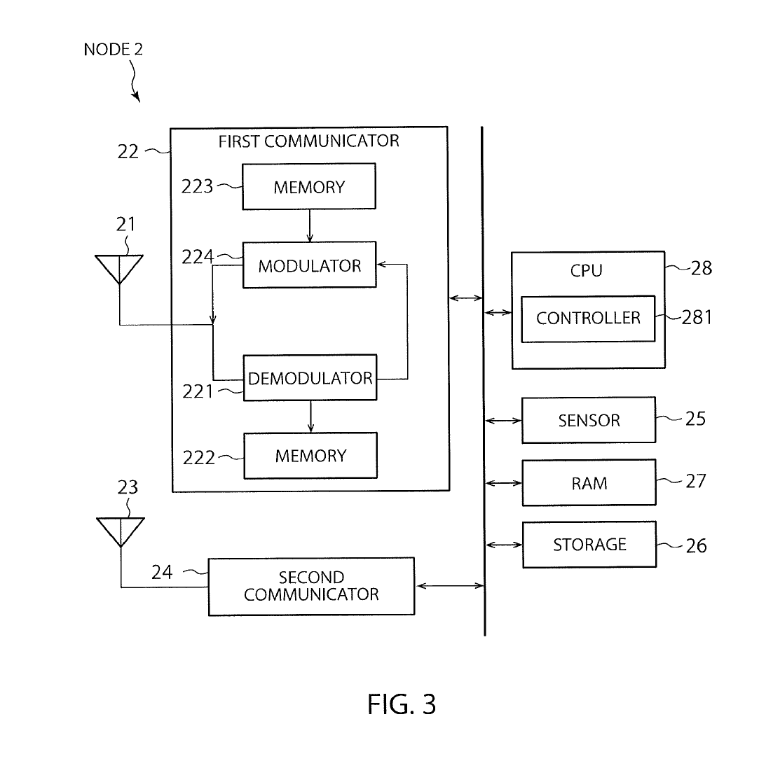

The configuration of the node 2 is described below. FIG. 3 is a diagram that illustrates the configuration of the node 2 in accordance with the first embodiment. As illustrated in FIG. 3, the node 2 includes an antenna 21, a first communicator 22 connected to the antenna 21, an antenna 23, a second communicator 24 connected to the antenna 23, a sensor 25, storage 26, RAM 27, and a CPU 28.

The first communicator 22, the second communicator 24, the sensor 25, the storage 26, the RAM 27 and the CPU 28 are interconnected via a bus so that information can be transmitted among these components.

The first communicator 22 is configured to carry out communications with the auxiliary terminal 3 via the antenna 21 using the short-range wireless communication scheme. Specifically, for example, the first communicator 22 receives the hub ID using the first communication scheme from the auxiliary terminal 3 which has received the hub ID from the hub 1 using the first communication scheme. The first communicator 12 is, for example, a modem, and specifically, for example, a passive RFID chip. Here, the first communicator 22 includes a demodulator 221, memory 222, memory 223, and a modulator 224. The first communicator 22 is a communication circuit and by way of example configured by an integrated circuit.

The demodulator 221 is configured to carry out demodulation of a reception signal that has been received via the antenna 21 from the auxiliary terminal 3 and store the hub ID wirelessly transmitted by the auxiliary terminal 3 in the memory 222.

A node ID which is a piece of information for identifying the node 2, and device identification information for identifying the first communicator 22 (which is hereinafter referred to as “second piece of device identification information”) are stored in the memory 223.

The modulator 224 is configured to read the node ID from the memory 223 and subject the node ID that has been read to modulation and wirelessly transmit a transmission signal obtained by the modulation via the antenna 21 to the auxiliary terminal 3.

The second communicator 24 is configured to carry out wireless communications with the hub 1 via the antenna 23 using the second communication scheme which is different from the short-range wireless communication scheme. For example, the second communicator 24 receives the hub ID from the hub 1 using the second communication scheme. The second communicator 24 is a communication circuit and, by way of example, configured by an integrated circuit.

The sensor 25 is configured to measure information regarding an object (e.g., a human body) on which the device itself is mounted. For example, when the device itself is mounted on the human body, the sensor 25 measures biological information of the human body on which the device itself is mounted.

Programs for controlling individual components of the device itself are stored in the storage 26. The storage 26 may be, for example, volatile memory such as SRAM and DRAM, non-volatile memory such as NAND and MRAM, a hard disk, or an SSD.

The random access memory (RAM) 27 is a volatile memory device that temporarily stores information.

The central processing unit 28 (CPU) reads programs from the storage 26 into the RAM 27 and executes these programs, and thus functions as the controller 281. The CPU 28 includes a control circuit that operates as the controller 281. The wireless communication integrated circuit in accordance with this embodiment includes the CPU 28 or the controller 281, and may further include a communication circuit which is the first communicator 22 and another communication circuit which is the second communicator 24.

The controller 281 is configured to control the second communicator 24. For example, the controller 281 compares the hub ID which has been received by the first communicator 22 using the first communication scheme with the hub ID that has been received by the second communicator 24 using the second communication scheme. In addition, the controller 281 causes the second communicator 24 to transmit a wireless signal (“connection request signal” in this embodiment) to the hub 1 using the second communication scheme in accordance with the result of comparison. The wireless signal (the connection request signal in this embodiment) is a wireless signal for establishing a connection to the wireless network.

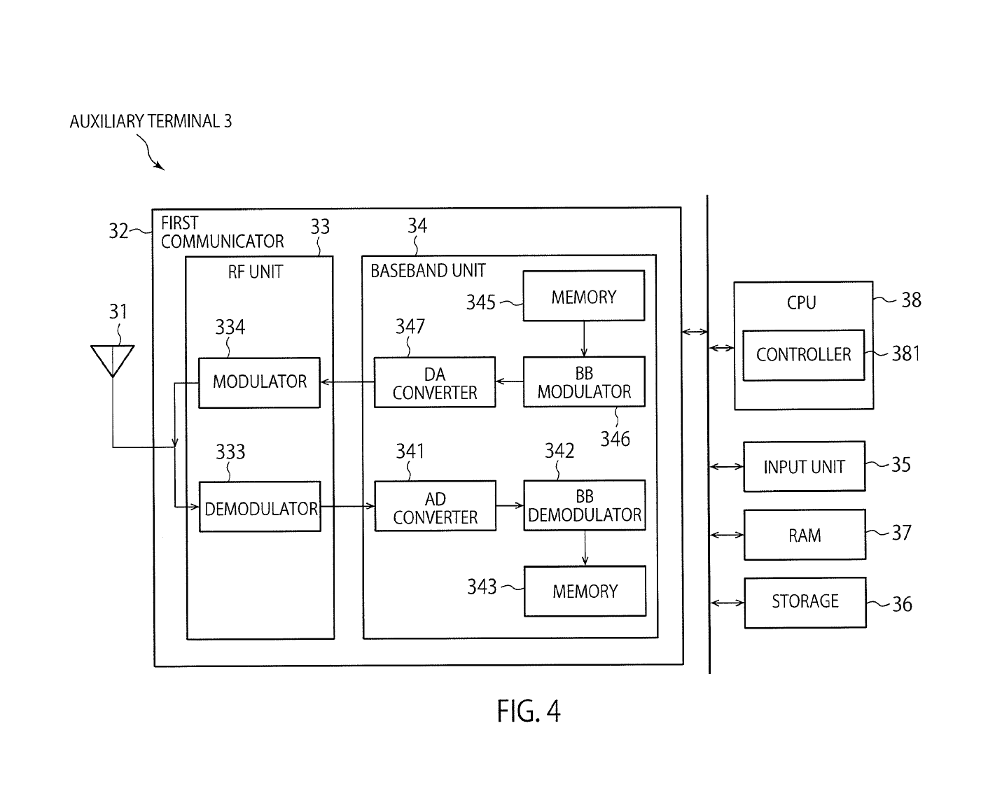

The configuration of the auxiliary terminal 3 is described below with reference to FIG. 4. FIG. 4 is a diagram that illustrates the configuration of the auxiliary terminal 3 in accordance with the first embodiment. As illustrated in FIG. 4, the auxiliary terminal 3 includes an antenna 31, a first communicator 32 connected to the antenna 31, an input unit 35, storage 36, RAM 37, and a CPU 38. The first communicator 32, the input unit 35, the storage 36, the RAM 37, and the CPU 38 are interconnected via a bus so that information can be transmitted among these components.

The first communicator 32 is configured to carry out wireless communications with the hub 1 and the node 2 using the first communication scheme. The first communication scheme is a scheme of communication according to which communications can be carried out when a distance from the communication partner falls within a prescribed distance range. The first communicator 32 is, for example, a modem, and specifically, for example, an RFID reader/writer.

Here, the first communicator 32 includes an RF unit 33 and a baseband unit 34. The RF unit 33 and the baseband unit 34 may be configured as a single-chip integrated circuit (IC) or may be configured as two separate chips.

The RF unit 225 is, for example, an RF analog IC or a radio-frequency IC. Here, the RF unit 33 includes a demodulator 333 and a modulator 334.

The demodulator 333 is configured to carry out analog processing at the time of reception. The reception circuit 227 includes a low noise amplifier (LNA) that amplifies the signal received by the antenna 31, a mixer configured to down-convert the amplified signal into a baseband using a signal having a constant frequency supplied from an oscillation device, a reception filter configured to extract signal of a desired band from the down-converted signal, and the like.

The modulator 334 is configured to carry out analog processing at the time of transmission. The modulator 334 includes a transmission filter that extracts a signal of a desired band from the signal of the frame DA-converted by the DA converter 347 which will be described later, a mixer that up-convert the filtered signal to a wireless radio frequency using a signal of a constant frequency supplied from an oscillation device, a pre-amplifier (PA) that amplifies the up-converted signal, and the like.

The baseband unit 34 is, for example, a baseband LSI or a baseband IC. Here, the baseband unit 34 includes an AD converter 341, a BB demodulator 342, memory 343, memory 345, a BB modulator 346, and a DA converter 347.

The AD converter 341 is an analog-to-digital conversion circuit. The AD converter 341 is configured to convert an analog signal input from the demodulator 333 into a digital signal and output the analog signal that has been converted to the BB demodulator 342.

The BB demodulator 342 is configured to carry out processing including demodulation, decoding, and analysis of a preamble and a physical header. The BB demodulator 342 stores the information transmitted from the hub 1 (e.g., the hub ID, and the time of the hub) in the memory 343.

Information to be transmitted to the node 2 is stored in the memory 345.

The BB modulator 346 is configured to read information from the memory 343 (e.g., the hub ID and the time of the hub) and read information from the memory 345 (e.g., the mounting positions and directions of the hub and the node). The BB modulator 346 carries out processing for the information that has been read including addition of a preamble and a physical header, coding and modulation.

The DA converter 347 is a digital-to-analog conversion circuit. The DA converter 347 is configured to convert the digital signal input from the BB modulator 346 to an analog signal and output the digital signal that has been converted to the modulator 334.

The input unit 35 is, for example, a touch panel that allows inputting of information by the user and indication of information. The input unit 35 receives, for example, the mounting positions and directions of the hub 1 and the node 2. The CPU 38 stores the mounting positions and directions of the hub 1 and the node 2 in the memory 345 as information to be transmitted to the node 2.

Programs for controlling individual components of the device itself are stored in the storage 36. The storage 26 is, for example, a non-volatile memory device.

The RAM 37 is a volatile memory device that temporarily stores information.

The CPU 38 functions as the controller 381 by reading programs from the storage 36 into the RAM 27 and executing these programs.

The controller 381 is configured to control the first communicator 32. For example, the controller 381 controls the first communicator 32 such that the first communicator 32 receives the hub ID from the hub 1 using the first communication scheme, and causes the first communicator 32 to transmit the hub ID, which has been received by the first communicator 32, from the first communicator 32 to the node 2 using the first communication scheme.

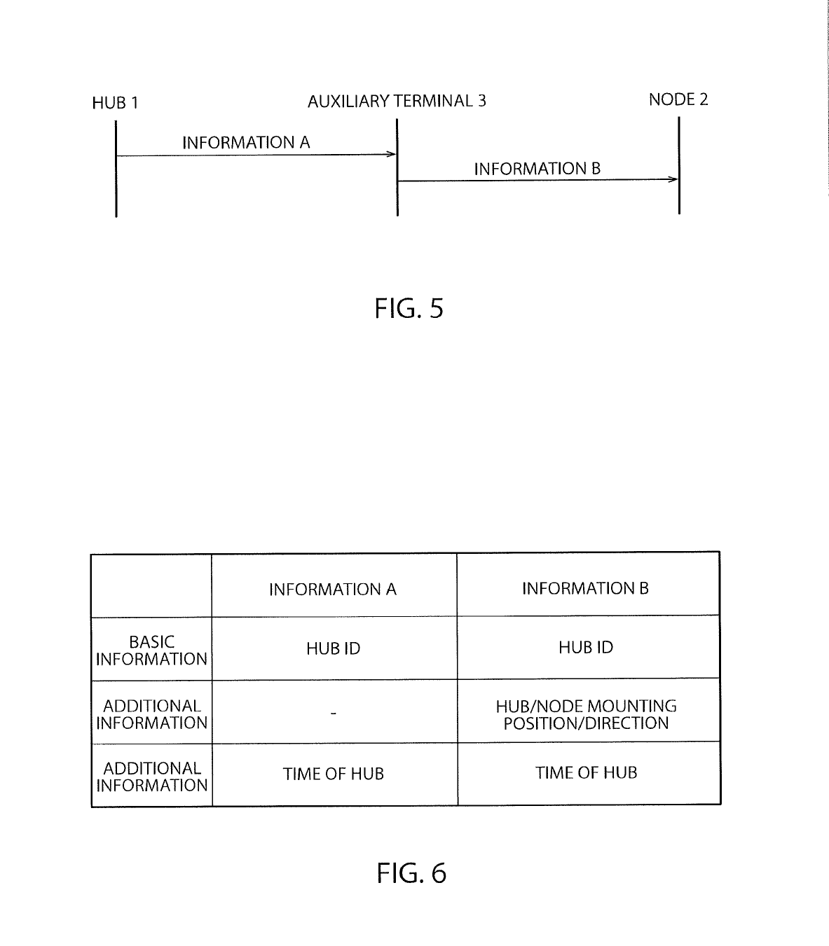

The information to be transmitted among the hub 1, the auxiliary terminal 3, and the node 2 using the communication system is described with reference to FIGS. 5 and 6. FIG. 5 is a diagram that illustrates the flow of information in accordance with the first embodiment. As illustrated in FIG. 5, information A is wirelessly transmitted from the hub 1 to the auxiliary terminal 3, and information B is transmitted from the auxiliary terminal 3 to the node 2.

FIG. 6 is a diagram that illustrates details of the pieces of information to be transmitted among the hub 1, the auxiliary terminal 3, and the node 2 in accordance with the first embodiment. As illustrated in FIG. 6, the information A includes the hub ID as basic information, and the time in the hub 1 as additional information. Also, the information B includes the hub ID as the basic information and the mounting positions and directions of the hub and the node and the time in the hub 1 as the additional information.

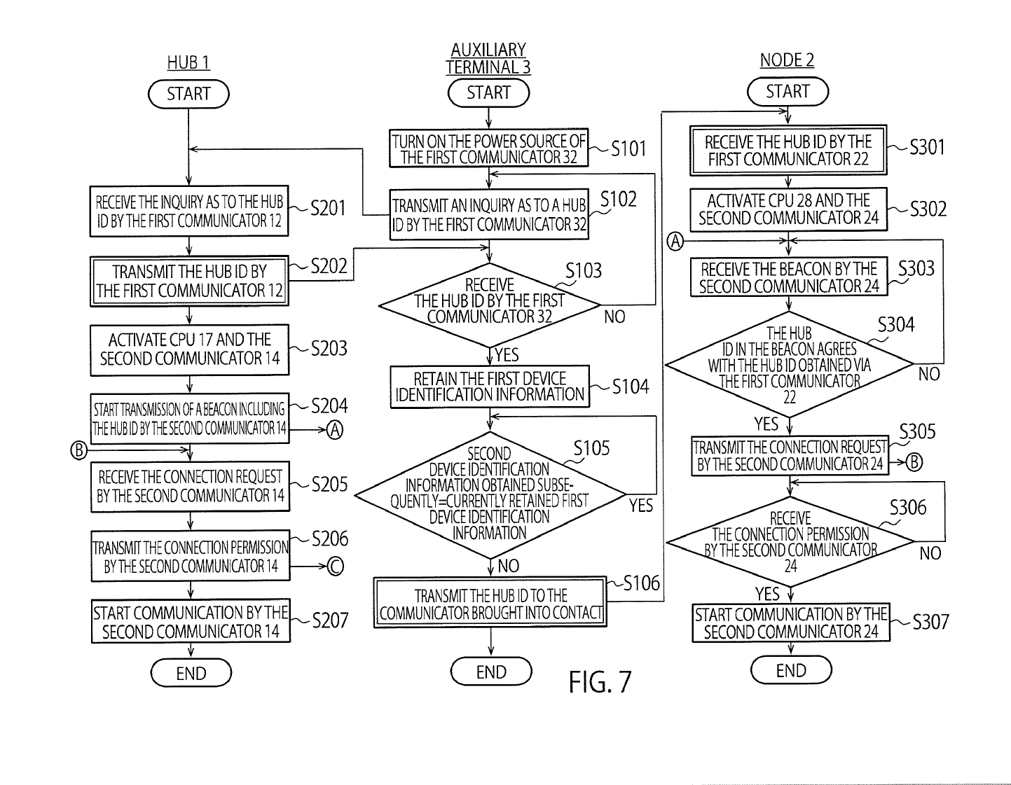

The wireless connection method for the node 2 to be connected to the wireless network formed by the hub 1 is described with reference to FIG. 7. FIG. 7 is a flowchart that illustrates an example of the wireless connection method for the node 2 to be connected to the wireless network formed by the hub 1. It should be noted that FIG. 7 describes a case where only the basic information illustrated in FIG. 6 is transmitted. It should also be noted that a process in which additional information may be transmitted is indicated using a double-line frame in FIG. 7.

As a premise, the CPU 17 of the hub 1 is initially driven in a low-power mode and the second communicator 14 of the hub 1 is stopped (i.e., does not consume any power). By virtue of this, power consumption can be reduced. It should be noted that the second communicator 14 of the hub 1 may be driven in the low-power mode.

Likewise, the CPU 28 of the node 2 is initially activated in the low-power mode, and the second communicator 24 of the node 2 is stopped (i.e., does not consume any power). By virtue of this, power consumption can be reduced. It should be noted here that the second communicator 24 of the node 2 may be driven in the low-power mode.
(Step S101) First, the controller 381 of the auxiliary terminal 3 turns on the power source of the first communicator 32.
(Step S102) Next, the user moves the auxiliary terminal 3 so that the auxiliary terminal 3 resides within a prescribed distance range from the hub 1. By virtue of this, the auxiliary terminal and the hub 1 are allowed to carry out wireless communications using the short-range wireless communication scheme. Next, the controller 381 of the auxiliary terminal 3 causes the first communicator 32 to transmit an inquiry as to the hub ID using the short-range wireless communication scheme. The hub ID can be received as a response to the inquiry only when the user brings the auxiliary device 3 and the hub 1 into contact with or vicinity to each other.
(Step S201) Next, the first communicator 12 of the hub 1 receives the inquiry as to the hub ID. The first communicator 12 sets a hub inquiry flag when it has received the inquiry as to the hub ID which is an example of the first identification information.
(Step S202) Next, the controller 171 causes the first communicator 12 to transmit the hub ID (which is an example of the first identification information) from the first communicator 12 to the auxiliary terminal 3 in accordance with the inquiry received in the step S201.
(Step S203) The controller 171 maintains constant monitoring of the hub inquiry flag. In addition, since the hub inquiry flag has been set in the step S201, the mode is switched to the full-power mode consuming larger power than that of the low-power mode. In addition, the controller 171 supplies power to the second communicator 14 and thereby activates the second communicator 14.
(Step S204) Next, the controller 171 reads from the storage 15 the hub ID which is an example of the second identification information and causes the second communicator 14 to start broadcast transmission, using a frequency channel 1, of a beacon including the hub ID (which is an example of the second pieces of identification information) and the frequency channel 2. The beacon is a signal intended for notification of the wireless network to other devices around the device itself. Also, by notifying the presence of the frequency channel 2 in this manner, the hub 1 is allowed to accept a connection request signal requesting a connection to the wireless network using the frequency channel 2.
(Step S103) The controller 381 of the auxiliary terminal 3 determines whether or not the first communicator 32 has received the hub ID which is an example of the first identification information. When the hub ID has not been received, the controller 381 of the auxiliary terminal 3 goes back to the step S102 and causes the first communicator 32 to transmit an inquiry as to the hub ID again. The first communicator 32, when receiving the hub ID using the short-range wireless communication scheme, receives a first piece of device identification information along with the hub ID. The first piece of device identification information is device identification information for identifying the first communicator 12 which is a communication partner.
(Step S104) When the hub ID has been received by the first communicator 32 in the step S103, then the first communicator 32 of the auxiliary terminal 3 retains the received first piece of device identification information along with the hub ID. Here, as has already been described, the device identification information is a value unique for each communicator. Next, the user moves the auxiliary terminal 3 to be close to the node 2 such that the auxiliary terminal 3 resides in a prescribed distance range from the node 2. By virtue of this, it is made possible to carry out wireless communications between the auxiliary terminal 3 and the node 2 using the short-range wireless communication scheme.

At this point, the controller 381 obtains the second piece of device identification information using the short-range wireless communication scheme, as a scheme of recognizing the fact that the device is brought into contact with or vicinity to a communication device which is different from the hub 1 to which the device was brought into contact or vicinity. The second piece of device identification information is device identification information identifying the first communicator 22 of the node 2 which is the communication partner newly brought into contact or vicinity.
(Step S105) In addition, the controller 381 of the auxiliary terminal 3 determines whether or not the obtained second piece of device identification information agrees with the retained first piece of device identification information.
(Step S106) When the second piece of device identification information obtained in the step S105 does not agree with the currently retained first piece of device identification information, then the controller 381 of the auxiliary terminal 3 determines that the device is brought into contact with or vicinity to the node 2, and causes the first communicator 32 to transmit the hub ID which is an example of the first identification information using the short-range wireless communication scheme to the communicator brought into contact or vicinity, i.e., the first communicator 22 of the node 2.

In this manner, the controller 381 of the auxiliary terminal 3 initially requests the device identification information from the node 2, and compares the second piece of device identification information received in accordance with the request with the retained first piece of device identification information. As a result of the comparison, when the two pieces of the device identification information are different from each other, then it can be recognized that this node 2 is a communication device that is different from the hub 1, and accordingly the controller 381 causes the first communicator 32 to transmit the hub ID to this node 2 from the first communicator 32. By virtue of this, the auxiliary terminal 3 is allowed to notify the hub ID obtained from the hub 1 to the node 2.
(Step S301) The first communicator 22 of the node 2 receives the hub ID wirelessly transmitted in the step S106 which is an example of the first identification information. In addition, since the first communicator 22 has received the hub ID, the first communicator 22 sets the hub acquisition flag.
(Step S302) The controller 281 of the node 2 maintains constant monitoring of the hub acquisition flag. In addition, since the hub acquisition flag has been set in the step S301, the mode is switched to the full-power mode consuming larger power than that of the low-power mode. In addition, the controller 281 supplies power to the second communicator 24 and thereby activates the second communicator 24.
(Step S303) Next, the second communicator 24 of the node 2 receives the beacon 1.
(Step S304) Next, the controller 281 of the node 2 determines whether or not the hub ID in the beacon 1 agrees with the hub ID obtained via the first communicator 22. At this point, the second communicator 24 of the node 2 carries out scanning for candidates for the frequency channel 1 and searches for the beacon 1 whose hub ID is in agreement therewith. When the hub ID is not in agreement, then the controller 281 of the node 2 goes back to the step S303 and waits for another beacon which will be received next time.
(Step S305) When it is determined in the step S304 that the hub IDs agree with each other, the controller 281 of the node 2 refers to the No. (i.e., identifier) of the frequency channel 2 included in the beacon 1 and waits for the reception of the beacon 2 using the frequency channel 2. In addition, when the second communicator 24 has received a beacon 2, the controller 281 of the node 2 refers to a start time t1 and an end time t2 included in the beacon 2. In addition, the controller 281 of the node 2 transmits a connection request signal from the second communicator 24 to the hub 1 using the frequency channel 2 at a time in a time period from the start time t1 to the end time t2.
(Step S205) The second communicator 14 of the hub 1 receives the connection request signal that has been transmitted from the node 2 in the step S305.
(Step S206) The controller 171 of the hub 1 causes the second communicator 14 to transmit a communication permission signal for this node 2. Here, the communication permission signal is a signal for permitting a connection to the wireless network.
(Step S207) The controller 171 of the hub 1 causes the second communicator 14 to start communication with the node 2 using the second communication scheme (i.e., start communication associated with the connection to the node 2).
(Step S306) After the step S305, the controller 281 of the node 2 determines whether or not the communication permission signal has been received by the second communicator 24.
(Step S307) When it is determined in step S306 that the communication permission signal has been received by the second communicator 24, then the controller 281 of the node 2 causes the second communicator 24 to start communication with the hub 1 using the second communication scheme (i.e., communication associated with the connection permitted by the communication permission signal).

Although the node 2 wirelessly in this embodiment transmits the connection request signal to the hub 1, by way of example, when the hub ID (which is an example of the first identification information) received from the auxiliary terminal 3 agrees with the hub ID (which is an example of the second identification information) received from the hub 1, this embodiment is not limited to this example. The node 2 may wirelessly transmit the connection request signal to the hub 1 when the hub ID (which is an example of the first identification information) received from the auxiliary terminal 3 and the hub ID (which is an example of the second identification information) received from the hub 1 have a predefined correspondence relationship.

As has been described in the foregoing, the first communicator 12 of the hub 1 in accordance with the first embodiment wirelessly transmits the hub ID (which is an example of the first identification information identifying the device itself) to the auxiliary terminal 3 when the distance from the auxiliary terminal 3 falls within the prescribed distance range. The second communicator 14 wirelessly transmits the hub ID (which is an example of the second identification information identifying the device itself) to the node 2. When the second communicator 14 has received the connection request signal from the node 2, the controller 171 causes the second communicator 14 to start wireless communication with the node 2 (start communication associated with the connection requested by the connection request signal).

Also, the first communicator 22 of the node 2 in accordance with the first embodiment wirelessly receives the hub ID from the auxiliary terminal 3 which received from the hub 1 this hub ID (which is an example of the first identification information identifying the hub 1) when the distance from the auxiliary terminal 3 falls within the prescribed distance range. The second communicator 24 wirelessly receives the hub ID (which is an example of the second identification information identifying the hub 1) from the hub 1. The controller 281 causes the second communicator 24 to transmit the connection request signal from the second communicator 24 to the hub 1 in accordance with the result of comparison of the first identification information received by the first communicator 22 with the second identification information received by the second communicator 24.

In other words, according to the wireless connection method in accordance with the first embodiment, when the distance from the auxiliary terminal 3 falls within the prescribed distance range, the hub 1 wirelessly transmits the hub ID (which is an example of the first identification information identifying the device itself) to the auxiliary terminal 3. Next, when the distance from the node 2 falls within the prescribed distance range, the auxiliary terminal 3 wirelessly transmits the hub ID (which is an example of the received first identification information) to the node 2. Next, the hub 1 wirelessly transmits the hub ID (which is an example of the second identification information identifying the device itself) to the node 2. The node 2 wirelessly transmits the connection request signal to the hub 1 in accordance with the result of comparison of the hub ID received from the auxiliary terminal 3 with the hub ID received from the hub 1.

By virtue of this, when the user moves the auxiliary terminal 3 such that the auxiliary terminal 3 becomes close to the hub 1 with which the node 2 should establish the communication and then moves the auxiliary terminal 3 such that the auxiliary terminal 3 becomes close to the node 2 as well, then it is made possible to reliably connect the node 2 to the hub 1 with which the communication should be established.

Here, there may be a sensor whose position of mounting on a body cannot be limited in advance depending on the types of the wearable sensor. Meanwhile, signals that can be sensed may vary depending on the mounting position on the body and/or the direction, in their signal waveforms, signal amplitudes, and relative times with respect to signals sensed by other sensors. For example, electrocardiographic waveforms may have difference waveforms depending upon the installation directions of the electrodes. Also, the amplitudes are larger near the heart, but they attenuate as they become away from the heart. In addition, pulse waves have larger amplitude in arms and at fingertips but delay with respect to the pulse waves obtained near the heart.

In view of this, in accordance with this embodiment, the input unit 35 of the auxiliary terminal 3 accepts from the user the information such as the mounting positions and directions of the hub 1 and the node 2. The mounting position and direction of the hub 1 as used herein refer to the mounting position and direction of the sensor of the hub 1. Also, the mounting position and direction of the node 2 as used herein refer to the mounting position and direction of the sensor of the node 2. In addition, as illustrated in FIG. 6, the auxiliary terminal 3 may transmit the mounting positions and directions of the hub and the node entered by the user to the node 2 as the additional information. Specifically, prior to the second step, the auxiliary terminal 3 accepts from an operator an input of the position direction information including the position and/or direction of at least either one of the hub 1 and the node 2. In addition, in the second step, the auxiliary terminal 3 wirelessly transmits, in addition to the hub ID, the accepted position direction information using the first communication scheme to the node 2.

By virtue of this, the node 2 is allowed to identify features such as the mounting position and direction of the sensor of the hub 1 and/or node 2. As a result, since the sensor as such is allowed to identify the information such as the mounting position and direction of the sensor, it is made possible to achieve more accurate sensing and signal analysis to analyze the measurement signal. Here, sensing as used herein refers to processing that includes measuring the biological information and obtaining the measurement signal. For example, since identification of the position of the sensor allows a gain at the time of measurement by the sensor to be specified as an appropriate value, it is made possible to improve the accuracy of the sensing. Also, for example, identification of the direction of the sensor enables extraction of an appropriate feature point, which makes it possible to improve the accuracy of the signal analysis.

The auxiliary terminal 3 may transmit to the hub 1 the mounting positions and directions of the hub and the node entered by the user. Specifically, prior to the first step, the auxiliary terminal 3 may accept from an operator an input of the position direction information including the position and/or direction of at least either one of the hub 1 and the node 2. In addition, in the first step, the auxiliary terminal 3 may wirelessly transmit the position direction information that has been accepted as described below to the hub 1 using the first communication scheme along with the inquiry as to the hub ID. By virtue of this, the hub is allowed to identify features such as the mounting position and direction of the sensor and the like.

Since the gain in accordance with the mounting position of the senor can be specified by identifying the mounting position of the sensor, the sensing becomes more accurate. For example, if the position of the communication device having a sensor mounted on an arm to measure pulse waves is known in advance, then it is made possible to determine, using the information on the mounting position, whether a delay in a rising time of the pulse wave measured on the arm is fast or slow with respect to a normal state, which makes it possible to improve the accuracy of estimation of a state of a blood vessel.

Also, in the case of an electrocardiographic sensor, the relative positions of the two electrodes with respect to muscles of a heart vary depending on the direction of the electrocardiographic sensor, so that the measured measurement signals also vary.

For example, the specific feature point of the electrocardiographic waveform that should be extracted can be recognized by identifying the direction of the electrocardiographic sensor. By virtue of this, the feature point in accordance with the direction of the electrocardiographic sensor can be extracted and, for example, the state of the blood vessel can be identified from the feature point.

Also, when signal waveforms sensed by multiple wearable terminals are integrated and analyzed, it is necessary to synchronize the times at which these signal waveforms were obtained or recognize the time differences thereof. The state where these times are synchronized or the state where the time differences thereof are recognized is referred to as a state where time synchronization is ensured.

For example, let us assume a case where the state of a blood vessel is to be determined based on a delay of a rising time of a pulse wave measured on an arm with respect to a rising time of a heart beat measured near a breast. In this case, it is necessary to accurately measure the delay in order to accurately determine the state of the blood vessel, and it is accordingly necessary that the time synchronization be ensured between or among the wearable terminals.

In view of this, as illustrated in FIG. 6, as the additional information, the hub 1 may transmit the time information to the auxiliary terminal 3, and the auxiliary terminal 3 in turn may transmit this time information to the node 2. Specifically, in the first step, the hub 1 may wirelessly transmit the internally managed time information in addition to the hub ID to the auxiliary terminal 3 using the first communication scheme. In addition, in the second step, the auxiliary terminal 3 may transmit this time information in addition to the hub ID to the node 2 using the first communication scheme.

By virtue of this, it is made possible to bring the times internally retained by the hub 1 and the node 2 into agreement with each other. As a result, it is made possible to more accurately identify a biological state of a human on which the sensor is mounted (e.g., the state of the blood vessel).

### Second Embodiment

The second embodiment is now described below. In the first embodiment, the node 2 receives the beacon and then transmits the connection request signal. This is because it is assumed that the information necessary for transmission of the connection request signal is included in the beacon.

Also, the communication system in accordance with the first embodiment uses two frequency channels and transmits the beacon 1 including the hub ID and the frequency channel 2 using the frequency channel 1, and thus notifies the presence of the frequency channel 2. In addition, the communication system accepts the connection request signal using the frequency channel 2.

Further, since the multiple candidates for the frequency channel 1 are present, the node 2 carries out scanning for the candidates for the frequency channel 1 and searches for the beacon whose hub ID is in agreement. Further, the beacon 2 is received using the frequency channel 2 and the connection request signal is transmitted using the information included in the beacon 2. As a consequence, the time required for establishing the connection becomes long necessitating power consumption corresponding to the extended time.

In view of this, a further problem to be addressed by this embodiment is to reduce the time required to establish the connection.

If one or more nodes are already connected to the hub, then the second communicator 14 is already activated. In the second embodiment, all or part of (i) the No. of the frequency channel 1 used by this second communicator 14, (ii) the No. of the frequency channel 2, (iii) the content of the beacon 1, and (iv) the content of the beacon 2 are transmitted from the first communicator 12 of the hub 1 via the first communicator 32 of the auxiliary terminal 3 to the first communicator 22 of the node 2. Here, the No. of the frequency channel 2 is an example of frequency channel identification information identifying a frequency channel used in the second communication scheme.

Here, the content of the beacon 1 includes at least the hub ID and may further include the version of the standard of the second communication scheme, the length of a frame, period of the beacon 1, and the like. The content of the beacon includes information necessary for transmission of the connection request signal, which may include, for example, the start time t1 and the end time t2 of the time period in which the hub 1 permits reception of the connection request signal, the period of the beacon 2, and the like.

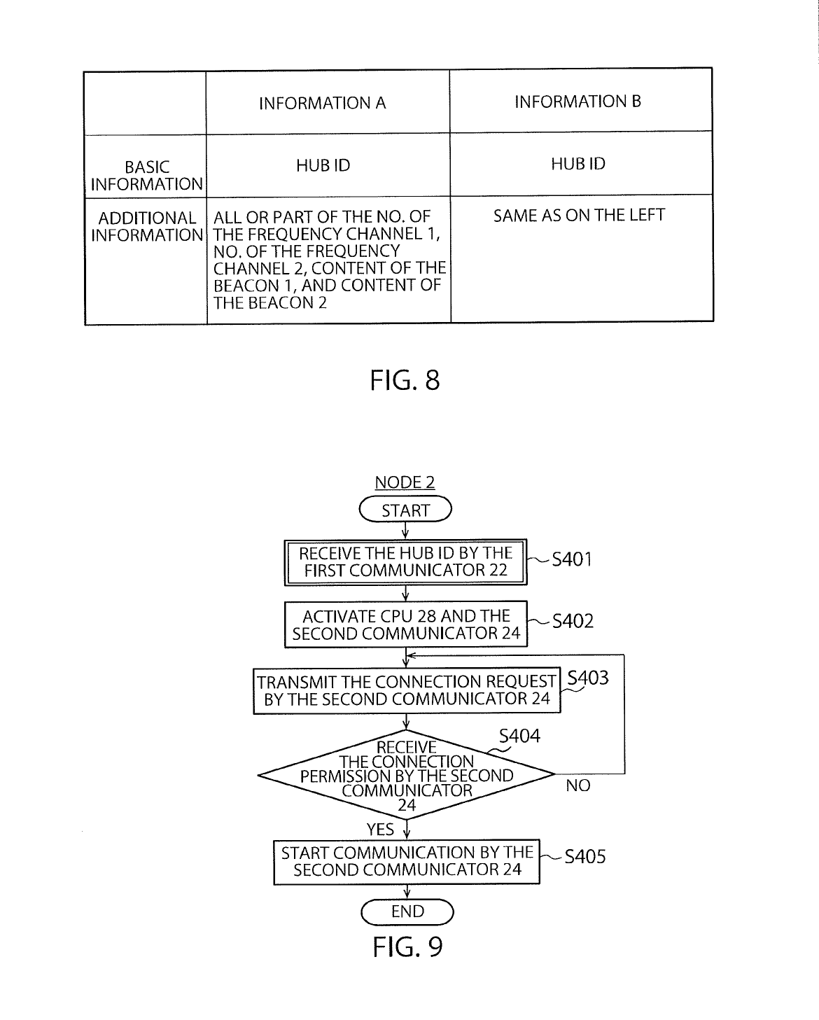

FIG. 8 is a table that indicates pieces of information to be transmitted in the second embodiment. The minimum necessary piece of information of the additional information of the information A and the information B illustrated in FIG. 8 is the No. of the frequency channel 2. This is because the node 2 can wait for the beacon 2 with the frequency having the No. of the frequency channel 2 and omit scanning for the beacon 1 as long as the No. of the frequency channel 2 is delivered from the hub 1 to the node 2.

The operation of the node 2 is described below with reference to FIG. 9. FIG. 9 is a flowchart that illustrates an example of the processing of the node 2 in a case where all the pieces of additional information illustrated in FIG. 8 are transmitted to the node 2.
(Step S401) First, the first communicator 22 of the node 2 receives, from the auxiliary terminal 3, (i) the hub ID, (ii) the No. of the frequency channel 1, (iii) the No. of the frequency channel 2, (iv) the content of the beacon 1, and (v) the content of the beacon 2. Also, since the first communicator 22 has received the hub ID, the first communicator 22 sets the hub acquisition flag.
(Step S402) The controller 281 of the node 2 maintains constant monitoring of the hub acquisition flag. As the hub acquisition flag has been set in the step S401, the controller 281 switches the mode from the low-power mode to the full-power mode which uses larger power consumption. In addition, the controller 281 supplies power to the second communicator 24 and thereby activate the second communicator 24.
(Step S403) Since the content of the beacon 2 received in the step S401 includes the start time t1 and the end time t2, the controller 281 of the node 2 causes the second communicator 241 to transmit the connection request signal with the frequency channel 2 at a time in the time period from the start time t1 and the end time t2.
(Step S404) The controller 281 of the node 2 determines whether or not the communication permission signal has been received by the second communicator 24.
(Step S405) When the communication permission signal has been received by the second communicator 24 in the step S404, the controller 281 of the node 2 causes the second communicator 24 to start communication (start communication associated with the connection permitted by the communication permission signal).

As has been described above, in the above-described first step in accordance with the second embodiment, the hub 1 transmits, in addition to the hub ID, the frequency channel identification information identifying the frequency channel used in the second communication scheme to the auxiliary terminal 3 using the first communication scheme. In addition, in the above-described second step, the auxiliary terminal 3 wirelessly transmits, in addition to the hub ID, the frequency channel identification information identifying the frequency channel used in the second communication scheme to the node 2 using the first communication scheme.

By virtue of this, since the need of changing the channels from the frequency channel 1 to the frequency channel 2 and the need of the scanning for the candidates of the frequency channel 1 are eliminated, it is made possible to reduce the time required for the connection.

### Third Embodiment

The third embodiment is described below. In the third embodiment, let us assume a case where numerous BANs are to be configured in a short period of time (e.g., at the site of disaster triage, etc.). In general, when multiple wireless terminals use one and the same channel at the same timing, mutual interferences occur, as a result of which transmission throughput is degraded. In response to this, a further problem that should be addressed by this embodiment is to resolve interferences between multiple BANs or between a BAN and another wireless communication system that is not a BAN at the time of an initial connection.

Since a BAN has a low data rate for a biological signal to be transmitted, it sometimes uses a narrowband channel. For example, if one channel width of the BAN is defined as 1 MHz and the operation frequency band as 2.4 GHz ISM (Industry-Science-Medical) band, then about 80 frequency channels are available. Alternatively, if the one channel width of the BAN is defined as 2 MHz, then about 40 frequency channels are available.

As a consequence, repeated use of these numerous frequency channels allows for reduction in the probability of occurrence of interference. Specifically, when a hub of the BAN starts utilization of the frequency channel, it carries out carrier sensing for all the frequency channels in advance, and, for example, uses a channel having the lowest reception signal level (i.e., the interference signal level).

Since some of the interference signals are intermittent ones such as a beacon signal, carrier sensing is required for the period or more per one frequency channel. Hence, carrier sensing of all the frequency channels requires a time that amounts to a carrier sensing time per one frequency channel multiplied by the total number of frequency channels. Also, power consumption corresponding thereto is required as well.

Also, in order to avoid interference caused by the communication system that is not a BAN (e.g., a wireless LAN), the most reliable approach is to provide a communicator capable of communications in the communication system (e.g., a modem) to carry out carrier sensing. However, such an approach is not desirable considering the requirements regarding reduction of the size of the wearable terminal and reduction in the power consumption.

In view of this, in accordance with the third embodiment, a solution to the above-identified problem is further sought by additionally providing, for the auxiliary terminal 3, a channel management and channel specification function for the channels of the communication system.

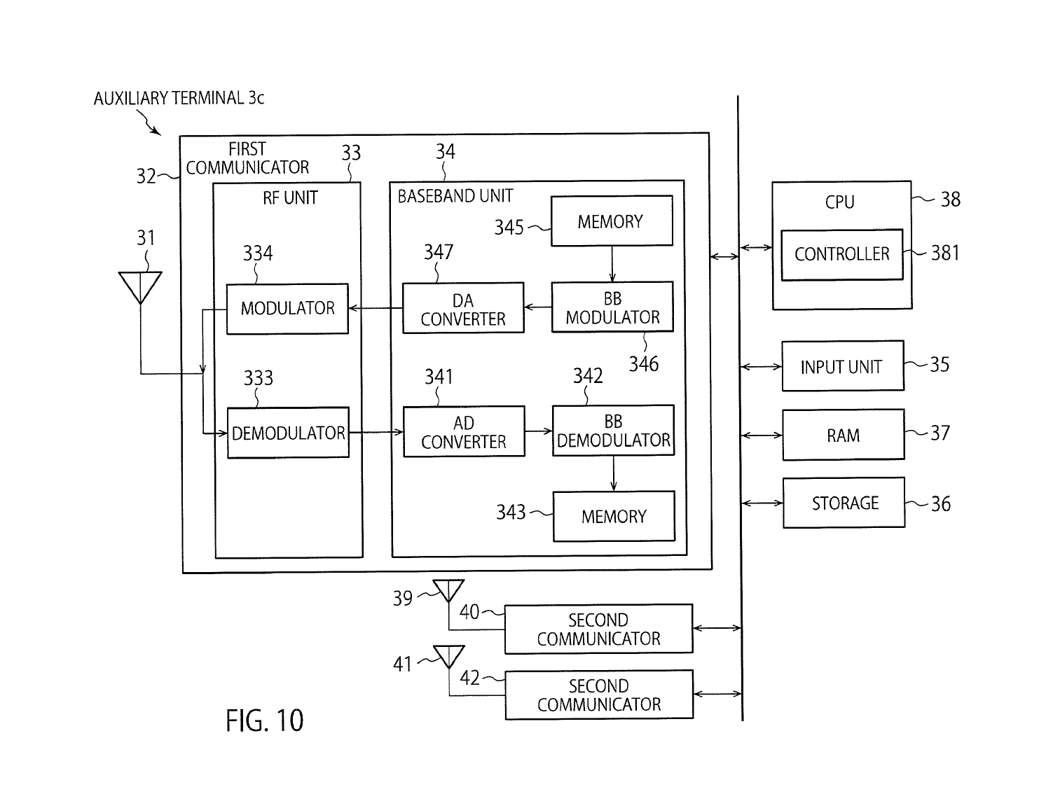

A configuration of an auxiliary terminal 3c in accordance with the third embodiment is described below. FIG. 10 is a diagram that illustrates the configuration of the auxiliary terminal 3c in accordance with the third embodiment. It should be noted that the elements that also appear in FIG. 4 have the same reference signs and specific descriptions thereof are not repeated here. As illustrated in FIG. 10, the configuration of the auxiliary terminal 3c in accordance with the third embodiment is based on the auxiliary terminal 3 in accordance with the first embodiment of FIG. 4 but it additionally incorporates an antenna 39, a second communicator 40, an antenna 41, and a second communicator 42.

The second communicator 40 is connected to the antenna 39 and is connected to other components via a bus. The second communicator 40 carries out wireless communications in a first wireless network using the second communication scheme.

The second communicator 42 is connected to the antenna 41 and is connected to other components via a bus. The second communicator 42 carries out wireless communications in a second wireless network, which is different from the first wireless network, using the second communication scheme.

The controller 381 of the auxiliary terminal 3c is configured to store in the storage 36 a frequency channel No. instructed for the hub 1 by the controller 381, and, when specifying a new frequency channel No. for the hub, instruct a channel No. other than this. Here, this frequency channel No. is one or more frequency channel Nos. used by the hub in carrying out communications using the second communication scheme. By virtue of this, since the frequencies used by hubs using the second communication scheme differ from each other, it is made possible to avoid interference in wireless communications.

The controller 381 may determine the frequency channel No. specified for the hub 1 in accordance with the reception signal intensity with the frequency channel currently used by the second communicator 40 and/or second communicator 42 or the frequencies respectively used by the second communicator 40 and the second communicator 42.

For example, the controller 381 makes an inquiry for the second communicator 40 and/or the second communicator 42 regarding the currently used frequency channel and determines a frequency channel other than the currently used frequency channel as the frequency channel No. specified for the hub 1.

For example, the controller 381 may cause the second communicator 40 and the second communicator 42 to recognize by carrier sensing the reception signal intensity of the respective frequencies used by the second communicator 40 and the second communicator 42, and determine the frequency channel having a lower reception signal intensity as the frequency channel No. specified for the hub 1. In this manner, the controller 381 may determine the frequency channel No. specified for the hub 1 in accordance with the reception signal intensity of the multiple frequency channels used by the multiple second communicators 40 and 42.

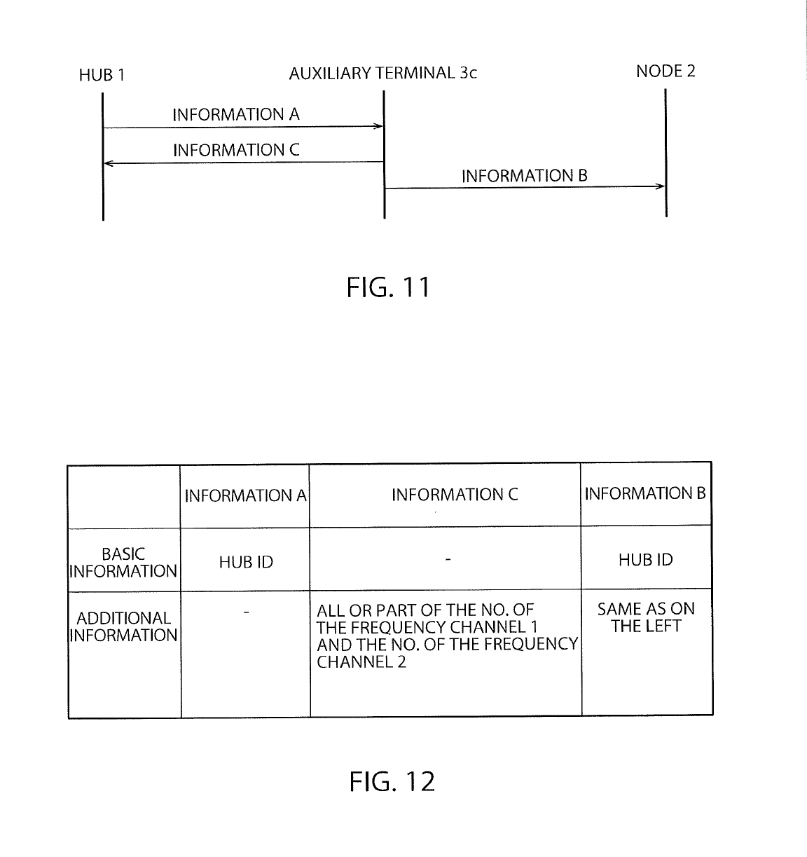

FIG. 11 is a diagram that illustrates a flow of information in accordance with the third embodiment. As illustrated in FIG. 11, the information A is wirelessly transmitted from the hub 1 to the auxiliary terminal 3c. Next, the information C is transmitted from the auxiliary terminal 3c to the hub 1. And the information B is transmitted from the auxiliary terminal 3c to the node 2.

FIG. 12 is a table that indicates pieces of information to be transmitted in accordance with the third embodiment. As illustrated in FIG. 12, with regard to the auxiliary terminal 3c, the information A includes a hub ID as its basic information. The information C includes, as its additional information, all or part of (i) the No. of the frequency channel 1 and (ii) the numbers of the frequency channel 2 used in the second communication scheme. The information B includes a hub ID as its basic information, and all or part of (i) the No. of the frequency channel 1 and (ii) the No. of the frequency channel 2 as its additional information. Meanwhile, it is preferable that the information C includes at least the No. of the frequency channel 1 as the additional information. By virtue of this, it is made possible to transmit the beacon 1 including the hub ID using the frequency channel 1 without the hub 1 carrying out carrier sensing.

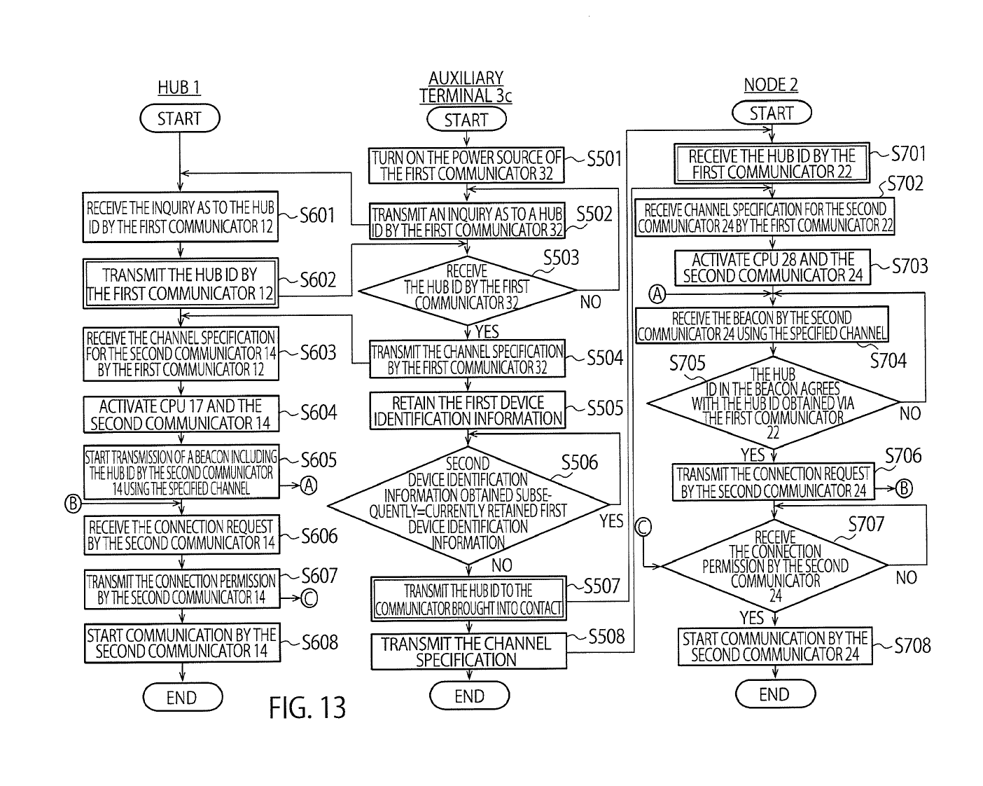

FIG. 13 is a flowchart that illustrates an example of a wireless connection method for the node 2 to be connected to the wireless network formed by the hub 1. FIG. 13 illustrates an example where the information C includes the No. of the frequency channel 1 and the No. of the frequency channel 2. Processing steps of FIG. 13 that differ from those of FIG. 7 are described below.

The processing steps S501 to S503 are identical to the steps S101 to S103 of FIG. 7, descriptions of which are not repeated here. The processing steps S201 and S202 are identical to the processing steps S601 and S602 of FIG. 7, descriptions of which are not repeated here, either.
(Step S504) When the auxiliary terminal 3c has received the hub ID by the first communicator 32, the auxiliary terminal 3c transmits the signal that includes the No. of the frequency channel 1 and the No. of the frequency channel 2 to the second communicator 14 of the hub 1.
(Step S603) The first communicator 12 of the hub 1 receives the signal that has been transmitted in the step S504.
(Step S604) The controller 171 of the hub 1 activates the second communicator 14 and starts transmission of the beacon 1 including the hub ID using the frequency channel 1.

It should be noted that the processing steps S505 to S507 are identical to the processing steps S104 to S106 of FIG. 7, descriptions of which are not repeated here.
(Step S508) After the step S507, the auxiliary terminal 3c transmits the signal that includes the No. of the frequency channel 1 and the No. of the frequency channel 2 to the node 2.
(Step S701) The first communicator 22 of the node 2 receives the signal that includes the hub ID transmitted in the step S507.
(Step S702) Next, the first communicator 22 of the node 2 receives the signal that includes the No. of the frequency channel 1 and the No. of the frequency channel 2 which has been transmitted in the step S508.
(Step S703) Next, the controller 281 of the node 2 switches the mode to the full-power mode consuming larger power than that of the low-power mode. Also, the controller 281 of the node 2 activates the second communicator 24.
(Step S704) Next, the second communicator 24 of the node 2 attempts reception of the beacon 1 using the frequency channel 1.
(Step S705) Next, the controller 281 of the node 2 determines whether or not the hub ID in the beacon 1 agrees with the hub ID obtained via the first communicator 22. When the hub IDs are not in agreement with each other, the controller 281 of the node 2 goes back to the step S303 and waits for another beacon 1 which will be received next time.
(Step S706) When it is determined in the step S705 that the hub IDs are in agreement with each other, then the controller 281 of the node 2 waits for reception of the beacon 2 using the frequency channel 2. In addition, when the second communicator 24 has received the beacon 2, the controller 281 of the node 2 refers to the start time t1 and the end time t2 included in the beacon 2. In addition, the controller 281 of the node 2 transmits the connection request signal from the second communicator 24 to the hub 1 using the frequency channel 2 at a time in a time period from the start time t1 to the end time t2.

It should be noted that the processing steps S705 to S708 are identical to the processing steps S304 to S307 of FIG. 7, descriptions of which are not repeated here.

As has been described in the foregoing, according to the third embodiment, in the above-described first step, the auxiliary terminal 3c wirelessly transmits the hub ID and wirelessly transmits the frequency channel identification information identifying the frequency channel used in the second communication scheme to the hub 1 using the first communication scheme. Here, the frequency channel identification information identifying the frequency channel used in the second communication scheme includes the No. of the frequency channel 1 used by the hub 1 to transmit the hub ID to the node 2 in the third step.

By virtue of this, the hub 1 is allowed to transmit the beacon 1 including the hub ID using the frequency channel 1 without carrying out carrier sensing. As a result, the hub 1 does not need to carry out carrier sensing for the candidates for the frequency channel 1 and select a frequency channel causing less interference with other communication systems, which makes it possible to shorten the processing time and reduce the power consumption.

Also, in the second step, the auxiliary terminal 3c wirelessly transmits, in addition to the hub ID, the frequency channel identification information identifying the frequency channel used in the second communication scheme to the node 2 using the first communication scheme. Here, the frequency channel identification information identifying the frequency channel used in the second communication scheme includes the No. of the frequency channel 1 used by the hub 1 to transmit the hub ID to the node 2 in the third step. By virtue of this, since the No. of the frequency channel 1 is also transmitted from the auxiliary terminal 3c to the node 2, the node 2 does not need to carry out scanning for the candidates for the frequency channel 1 and searching for the beacon 1. As a result, the time required for establishing a connection is shortened.

Although the auxiliary terminal 3c in accordance with the third embodiment includes two communicators for communications using the second communication scheme, i.e., the second communicator 40 and the second communicator 42, the present invention is not limited to this configuration and there may be only one communicator that carries out communications using the second communication scheme, or three or more communications may be provided. In other words, it suffices that the auxiliary terminal 3c includes at least one communicator that carries out communications using the second communication scheme.

In this case, the controller 381 may specify, for the hub 1, a frequency channel other than the frequency channel currently used by the communicator that carries out communications using the second communication scheme. By virtue of this, interference with wireless communication systems can be avoided. Also, the controller 381 may specify, for the hub 1, a frequency channel that is not the frequency channel currently used by the communicator carrying out communications using the second communication scheme but a frequency channel not assigned to any other hubs.

Also, the controller 381 may specify, for the hub 1, a frequency channel having the lowest reception signal intensity among the reception signal intensities of the respective frequency channels used by the communicator that carries out communications using the second communication scheme. Also, the controller 381 may specify, for the hub 1, a frequency channel which is not assigned to any other hub and has the lowest reception signal intensity among the reception signal intensities at the respective frequencies used by the communicator that carries out communications using the second communication scheme.

### Fourth Embodiment

The fourth embodiment is described below. In the first to third embodiments, the user brings the auxiliary terminal into contact with or vicinity to the hub and the node in this order. In contrast, in accordance with the fourth embodiment, the user brings it into engagement or vicinity to the node and the hub in this order. Also, in the first to third embodiments, the connection request signal requesting a connection to the wireless network is used as the wireless signal for establishing the connection to the wireless network. In contrast, in accordance with the fourth embodiment, a communication permission signal giving permission to be connected to the wireless network is used as the wireless signal for establishing the connection to the wireless network. The configurations of the hub 1, the node 2, and the auxiliary terminal 3 in accordance with the fourth embodiment are identical or similar to those of the hub 1, the node 2, and the auxiliary terminal 3 in the first embodiment, descriptions of which are not repeated.

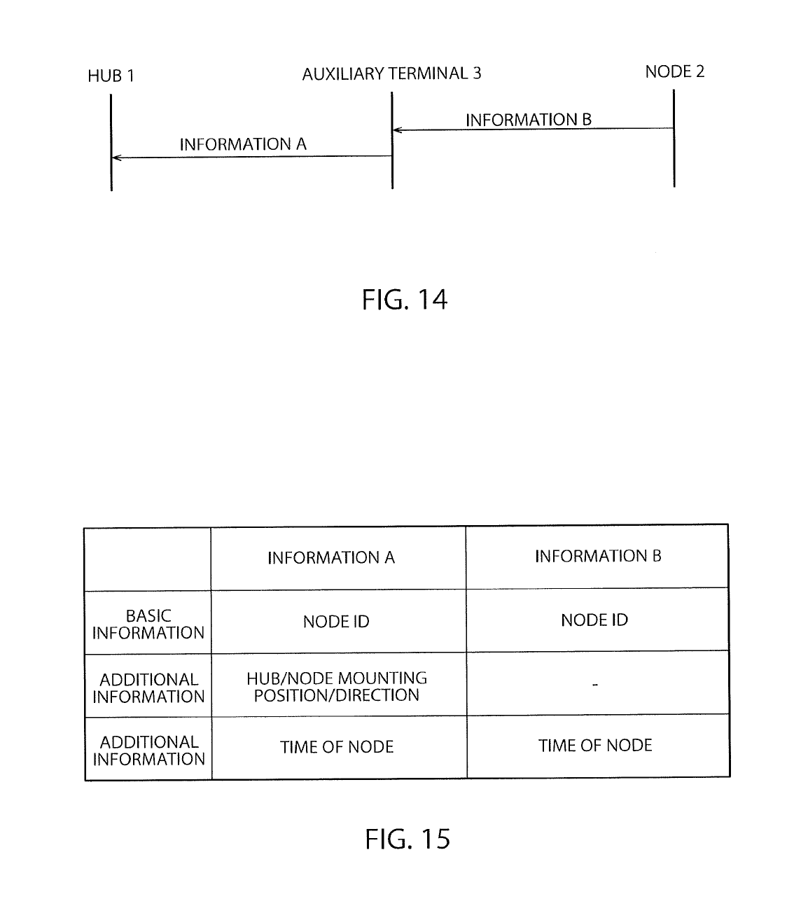

FIG. 14 is a diagram that illustrates the flow of information in accordance with the fourth embodiment. As illustrated in FIG. 14, the information B is wirelessly transmitted from the node 2 to the auxiliary terminal 3, and the information A is transmitted from the auxiliary terminal 3 to the hub 1.

FIG. 15 is a table that indicates pieces of information to be transmitted in accordance with the fourth embodiment. As illustrated in FIG. 15, the information A includes the node ID as its basic information, and the mounting positions and directions of the hub 1 and the node 2, and the time managed by the node 2 as its additional information. The information B includes the node ID as its basic information, and the time managed by the node 2 as its additional information. In the following, in accordance with this embodiment and in contrast to the above-described embodiments, a first identification information which is identification information identifying the node 2 is stored in the memory 223 of the node 2, and this first identification information is, as one example, a node ID. Also, in this embodiment, in contrast to the above-described embodiments, a second identification information which is identification information identifying the node 2 is stored in the storage 26 of the node 2. The second identification information is, by way of example, a node ID.

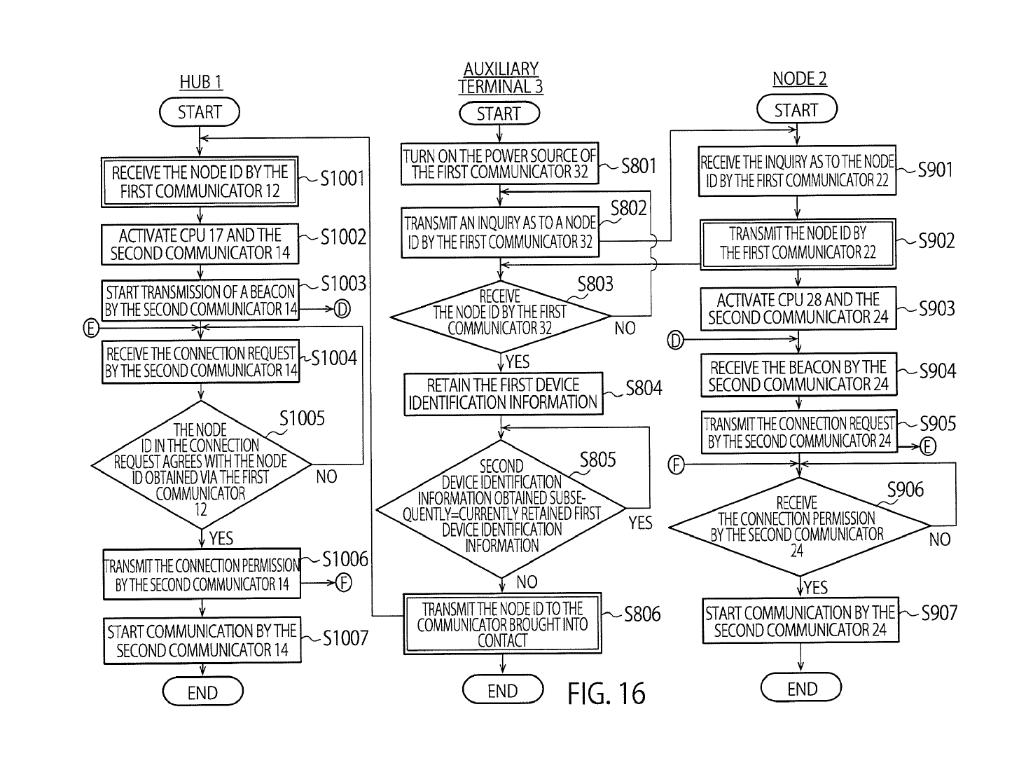

The operation in a case where only the basic information of FIG. 15 is exchanged is described below with reference to FIG. 16. FIG. 16 is a flowchart that illustrates an example of a wireless connection method for the node 2 to be connected to the wireless network formed by the hub 1. In FIG. 16, a process in which the additional information may be transmitted is indicated by a double-line frame.
(Step S801) First, the controller 381 of the auxiliary terminal 3 turns on the power source of the first communicator 32.
(Step S802) Next, the user moves the auxiliary terminal 3 such that the auxiliary terminal 3 resides within a prescribed distance range from the node 2. By virtue of this, the auxiliary terminal and the node 2 are allowed to carry out wireless communications using the short-range wireless communication scheme. The controller 381 of the auxiliary terminal 3 causes the first communicator 32 to transmit an inquiry as to the node ID from the first communicator 32 using the short-range wireless communication scheme. The auxiliary terminal 3 is allowed to receive the hub ID as a response to the inquiry only when the auxiliary terminal 3 and the node 2 reside in the prescribed distance range.
(Step S901) Next, the first communicator 22 of the node 2 receives the inquiry as to the node ID wirelessly transmitted from the auxiliary terminal 3 in the step S802. In addition, since the first communicator 22 has received the inquiry as to the node ID, the first communicator 22 sets the hub inquiry flag.
(Step S902) Next, the first communicator 22 transmits the node ID (which is an example of the first identification information) to the auxiliary terminal 3 in accordance with the inquiry received in the step S901.
(Step S903) The controller 281 maintains constant monitoring of the hub inquiry flag. In addition, since the hub inquiry flag has been set in the step S901, the mode is switched to the full-power mode consuming larger power than that of the low-power mode. In addition, the controller 281 supplies power to the second communicator 24 and thereby activates the second communicator 24.
(Step S803) It is determined whether or not the node ID has been received by the first communicator 32 of the auxiliary terminal 3. When the node ID has not been received, the controller 381 of the auxiliary terminal 3 goes back to the step S802 and causes the first communicator 32 to transmit an inquiry as to the node ID again from the first communicator 32. The first communicator 32, when receiving the node ID using the short-range wireless communication scheme, receives, along with the node ID, the device identification information identifying the first communicator 22 which is the communication partner. In the following, in accordance with this embodiment and in contrast to the above-described embodiments, the device identification information identifying the first communicator 22 of the node 2 is referred to as the first piece of device identification information.
(Step S804) When the first communicator 32 has received the node ID in the step S803, the first communicator 32 of the auxiliary terminal 3 retains the received first piece of device identification information along with the node ID. Here, as has already been described, the device identification information is a unique value for each communicator. Next, the user moves the auxiliary terminal 3 such that the auxiliary terminal 3 resides within a prescribed distance range from the hub 1. By virtue of this, the auxiliary terminal 3 and the hub 1 are allowed to carry out wireless communications using the short-range wireless communication scheme.

At this point, the controller 381 obtains the device identification information of the communicator of the communication partner newly brought into contact or vicinity, i.e., the first communicator 12 of the hub 1 using the short-range wireless communication scheme, as a scheme of recognizing the fact that the device is brought into contact with or vicinity to a communication device which is different from the node 2 which was brought into contact or vicinity. In the following, in accordance with this embodiment and in contrast to the above-describe embodiments, the device identification information of the first communicator 12 of the hub 1 is referred to as the second piece of device identification information.
(Step S805) In addition, the controller 381 of the auxiliary terminal 3 determines whether or not the obtained second piece of device identification information agrees with the currently retained first piece of device identification information.
(Step S806) When the second piece of device identification information obtained in the step S805 does not agree with the currently retained first piece of device identification information, then the controller 381 of the auxiliary terminal 3 determines that the device is brought into contact with or vicinity to the hub 1, and causes the first communicator 32 to transmit the node ID (which is an example of the first identification information) from the first communicator 32 to the communicator brought into contact or vicinity, i.e., the first communicator 12 of the hub 1, using the short-range wireless communication scheme.

In this manner, the controller 381 of the auxiliary terminal 3 initially requests the device identification information from the hub 1, and compares the second piece of device identification information received in accordance with the request with the retained first piece of device identification information. As a result of the comparison, when the two pieces of the device identification information are different from each other, then it can be recognized that this hub 1 is a communication device that is different from the node 2, and accordingly the controller 381 causes the first communicator 32 to transmit the node ID (which is an example of the first identification information) to this hub 1 from the first communicator 32. By virtue of this, auxiliary terminal 3 is allowed to notify the node ID obtained from the node 2 to the hub 1.
(Step S1001) The first communicator 12 of the hub 1 receives the node ID wirelessly transmitted in the step S806. In addition, since the first communicator 12 has received the node ID, the first communicator 12 sets the node ID acquisition flag.
(Step S1002) The controller 171 of the hub 1 maintains constant monitoring of the node ID acquisition flag. In addition, the node ID acquisition flag has been set in the step S1001, the mode is switched to the full-power mode consuming larger power than that of the low-power mode. In addition, the controller 281 supplies power to the second communicator 24 and thereby activates the second communicator 24.
(Step S1003) Next, the controller 171 of the hub 1 causes the second communicator 14 of the hub 1 to start transmission of the beacon 1 from the second communicator 14 using the frequency channel 1.
(Step S904) Next, the second communicator 24 of the node 2 receives the beacon 1 transmitted using the frequency channel 1 in the step S1003. The second communicator 24 of the node 2 waits, using the frequency channel 2 included in the beacon 1, for reception of the beacon 2 transmitted from the hub 1 using the frequency channel 2.
(Step S905) When the second communicator 24 of the node 2 has received the beacon 2 from the hub 1, the second communicator 24 refers to the start time t3 and the end time t4 included in the beacon 2, and the controller 281 of the node 2 causes the second communicator 24 to transmit the connection request signal including the node ID to the hub 1 during the period from the start time t3 to the end time t4.
(Step S1004) Next, the second communicator 14 of the hub 1 receives, with the frequency channel 2, the connection request signal transmitted from the node in the step S904.
(Step S1005) Next, it is determined whether or not the second identification information (here, the node ID as an example) in the connection request signal received in the step S1004 agrees with the first identification information obtained via the first communicator 12 (here, the node ID as an example). Here, the node ID via the first communicator 12 is the node ID that has been received in the step S1001.
(Step S1006) Next, the controller 171 of the hub 1 transmits the communication permission signal from the second communicator 14 to the node 2.
(Step S1007) Next, the controller 171 of the hub 1 causes the second communicator 14 to start communication with the node 2 (start communication associated with the connection permitted by the communication permission signal).
(Step S906) Next, the second communicator 24 of the node 2 receives the communication permission signal transmitted from the hub 1 in the step S1006.
(Step S907) Next, the controller 281 of the node 2 causes the second communicator 24 to start communications with the hub 1 (start communications associated with the connection permitted by the communication permission signal).

In accordance with this embodiment, by way of example, the hub 1 wirelessly transmits the connection request signal to the node 2 when the node ID (which is an example of the first identification information) received from the auxiliary terminal 3 agrees with the node ID (which is an example of the second identification information) received from the node 2. However, this embodiment is not limited to this configuration. The hub 1 may wirelessly transmit the connection request signal to the node 2 when the node ID (which is an example of the first identification information) received from the auxiliary terminal 3 and the node ID (which is an example of the second identification information) received from the node 2 have a predefined correspondence relationship.

As has been described in the foregoing, according to the fourth embodiment, the first communicator 12 of the hub 1 in accordance with the fourth embodiment wirelessly receives the node ID from the auxiliary terminal 3 that received this node ID (which is an example of the first identification information identifying the node 2) from the node 2. The second communicator 14 wirelessly receives the node ID (which is an example of the second identification information identifying the node 2) from the node 2. The controller 171 causes the second communicator 14 to transmit the communication permission signal from the second communicator 14 to the node 2 in accordance with the result of comparison of the node ID which is an example of the first identification information received by the first communicator 12 with the node ID which is an example of the second identification information received by the second communicator 14.

Also, the first communicator 22 of the node 2 in accordance with the fourth embodiment wirelessly transmits the node ID (which is an example of the first identification information identifying the device itself) to the auxiliary terminal 3 when the distance from the auxiliary terminal 3 falls within the prescribed distance range. The second communicator 24 wirelessly transmits the node ID (which is an example of the second identification information identifying the device itself) to the hub 1. When the second communicator 24 has received the communication permission signal from the hub 1, the controller 281 causes the second communicator 24 to start wireless communications with the hub 1 (communications associated with the connection permitted by the communication permission signal).

In other words, when the distance from the auxiliary terminal 3 falls within the prescribed distance range, the node 2 wirelessly transmits the node ID (which is an example of the first identification information identifying the device itself) to the auxiliary terminal 3. Next, when the distance from the hub 1 falls within the prescribed distance range, the auxiliary terminal 3 wirelessly transmits the received node ID to the hub 1. Next, the node 2 wirelessly transmits the node ID (which is an example of the second identification information identifying the device itself) to the hub 1 using the second communication scheme. Next, the hub 1 wirelessly transmits the communication permission signal to the node 2 in accordance with the result of comparison of the node ID which is an example of the first identification information received from the auxiliary terminal 3 with the node ID which is an example of the second identification information received from the node 2.

By virtue of this, it is made possible to reliably connect the node 2 to the hub 1 with which communications should be established when the user moves the auxiliary terminal 3 such that the auxiliary terminal 3 becomes close to the node 2 and then moves the auxiliary terminal 3 such that the auxiliary terminal 3 becomes close to the hub 1 with which the node 2 should establish the communication.

Also, the auxiliary terminal 3 may transmit, to the hub 1, the mounting positions and directions of the hub and the node entered by the user into the auxiliary terminal 3 (the mounting positions and directions are transmitted as the additional information). By virtue of this, the hub 1 is allowed to identify the mounting positions and directions of the sensor 18 of the hub 1 and the sensor 25 of the node 2.

It should be noted that the auxiliary terminal 3 may transmit, to the node 2, the mounting positions and directions of the hub and the node entered by the user into the auxiliary terminal 3 as the additional information. By virtue of this, the node 2 is allowed to identify the features such as the mounting positions and directions of the sensor 18 of the hub 1 and the sensor 25 of the node 2.

Also, the node 2 may transmit the time information to the auxiliary terminal as the additional information and the auxiliary terminal may in turn transmit this time information to the hub 1. By virtue of this, it is made possible to synchronize the times internally retained by the hub 1 and the node 2 with each other, i.e., to ensure the time synchronization.

### Fifth Embodiment

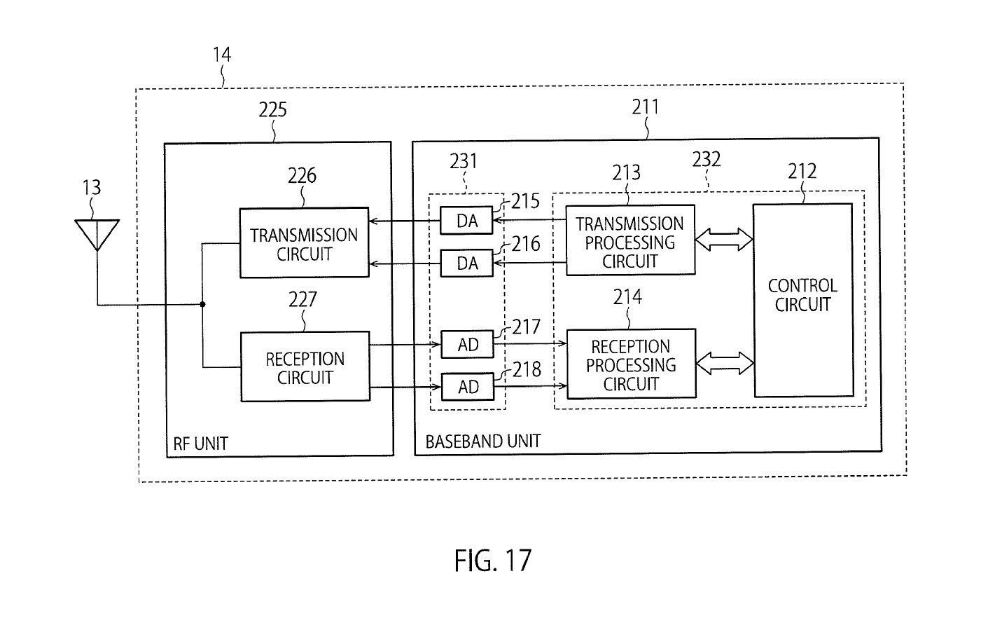

The fifth embodiment is described below. In the fifth embodiment, examples of hardware configurations of the second communicator 14 of the hub 1 and the second communicator 24 of the node 2 in accordance with the first embodiment are described below. First, an example of the hardware configuration of the second communicator 14 of the hub 1 in accordance with the first embodiment is described with reference to FIG. 17.

### (Example of the Hardware Configuration of the Second Communicator 14 of the Hub 1)

FIG. 17 is a diagram that illustrates an example of the hardware configuration of the second communicator 14 of the hub 1 in accordance with the first embodiment. This hardware configuration is merely one example and various modifications may be made to the hardware configuration.

The second communicator 14 includes a baseband unit 211, an RF unit 225, and at least one antenna 13.

The baseband unit 211 includes a control circuit 212, a transmission processing circuit 213, a reception processing circuit 214, DA conversion circuits 215, 216, and AD conversion circuits 217, 218. The RF unit 221 and the baseband unit 211 may be collectively configured as one-chip IC (integrated circuit) or may be configured as independent chips.

As one example, the baseband unit 211 is a baseband LSI or a baseband IC or both of them. Alternatively, the baseband unit 211 may include an IC 232 and an IC 231 in the illustrated manner as indicated by dotted lines. In this context, components may be incorporated in a distributed manner on these ICs such that the IC 232 includes the control circuit 212, the transmission processing circuit 213, and the reception processing circuit 214 while the IC 231 includes the DA conversion circuits 215, 216 and the AD conversion circuits 217, 218. The IC 232 may be one chip IC or configured by a plurality of chip ICs.

The control circuit 212 is mainly configured to execute the functionality of the MAC (Media Access Control) layer. The functionality of the upper layer may be included in the control circuit 212. The control circuit 212 or IC 232 corresponds, for example, to a communication processing device for controlling communication or a controller for controlling communication. The wireless communicator according to the embodiment may include a transmission circuit 226 and a reception circuit 227. The wireless communicator may include further DA conversion circuits 215, 216 and the DA conversion circuits 217, 218 in addition to the transmitting circuit 226 and the receiving circuit 227. The wireless communicator may include the transmission processing circuit 213 and the reception processing circuit 214, along with the transmitting circuit 226 and the receiving circuit 227, DA conversion circuits 215, 216 and the DA conversion circuits 217, 218. The integrated circuit according to the embodiment includes a processor which performs all or a part of processing of the baseband unit 211, that is, all or a part of processing of: the control circuit 212, the transmission processing circuit 213 and the reception processing circuit 214, the DA conversion circuits 215, 216 and the DA conversion circuits 217, 218.

The transmission processing circuit 213 performs processing associated with addition of a preamble and a PHY header, encoding, modulation and generates, for example, two types of digital baseband signals (hereinafter referred to as the digital I-signal and Q-signal). In a case of MIMO transmission, two kinds of digital baseband signals are generated for each of steams.

The reception processing circuit 214 performs processing such as demodulating, decoding and analyzing of the preamble and the PHY header.

The DA conversion circuits 215 and 216 are configured to perform digital-to-analog conversion for the signals input from the transmission processing circuit 213. More specifically, the DA conversion circuit 215 converts a digital I-signal into an analog I-signal, and the DA conversion circuit 216 converts a digital Q-signal into an analog Q-signal. It should be noted that there may be a case where the signals are transmitted as single-channel signals without the quadrature modulation being performed. In this case, it suffices that one single DA conversion circuit is provided. In addition, when transmission signals of one single channel or multiple channels are transmitted in a distributed manner in accordance with the number of antennas, DA conversion circuits may be provided in the number corresponding to the number of the antennas.

The RF unit 221, by way of example, is an RF analog IC or a high-frequency wave IC. The transmitting circuit 226 in the RF unit 225 includes a transmission filter that extracts a signal of a desired bandwidth from the signal of the frame that has been subjected to the digital-to-analog conversion by the DA conversion circuits 215 and 216, a mixer that performs up-conversion for the signal that has been subjected to the filtering to the radio frequency using a signal having a predetermined frequency supplied from an oscillation device, a pre-amplifier (PA) that performs amplification for the signal that has been subjected to the up-conversion, and the like.

The receiving circuit 227 in the RF unit 225 includes an LNA (low noise amplifier) that amplifies the signal received by the antenna, a mixer that performs down-conversion of the amplified signal to the baseband using a signal having a predetermined frequency supplied from an oscillation device, a reception filter that extracts a signal of a desired bandwidth from the signal that has been subjected to the down-conversion, and the like. More specifically, the receiving circuit 227 performs quadrature demodulation for the reception signal, which has been subjected to the low noise amplification by a low noise amplifier, by carrier waves with 90 degree phase shift with respect to each other and thus generates an I-signal (In-phase signal) having the same phase as that of the reception signal and a Q-signal (Quad-phase signal) whose phase is delayed by 90 degrees with respect to the reception signal. The I-signal and the Q-signal are output from receiving circuit 227 after being subjected to the gain adjustment.

The control circuit 212 may control the operation of the transmission filter of the transmitting circuit 226 and the reception filter of the receiving circuit 227 according to the setting of a used channel. Another controller that controls the transmitting circuit 226 and the receiving circuit 227 may be provided and the same or similar control may be realized by the control circuit 212 sending instructions to that controller.

The AD conversion circuits 217, 218 in the baseband unit 211 perform analog-to-digital conversion for the input signal that is input from the receiving circuit 227. More specifically, the AD conversion circuit 217 converts the I-signal into a digital I-signal and the AD conversion circuit 218 converts the Q-signal into a digital Q-signal. It should be noted that quadrature demodulation may not be performed and only a single-channel signal may be received. In this case, only one AD conversion circuit has to be provided. In addition, when a plurality of antennas are provided, AD conversion circuits in the number corresponding to the number of the antennas may be provided.

It should be noted that a switch may be arranged in the RF unit for switching the antenna 13 between the transmitting circuit 226 and the receiving circuit 227. By controlling the switch, the antenna 13 may be connected to the transmitting circuit 226 at the time of transmission and the antenna 13 may be connected to the receiving circuit 227 at the time of reception.

Although the DA conversion circuits 215, 216 and the AD conversion circuits 217, 218 are arranged on the side of the baseband unit 211 in FIG. 17, another configuration may be adopted where they are arranged on the side of the RF unit 225.

The configuration of FIG. 17 is one example and the present embodiment is not restricted to the configuration.

### (Example of the Hardware Configuration of the Second Communicator 24 of the Node 2)

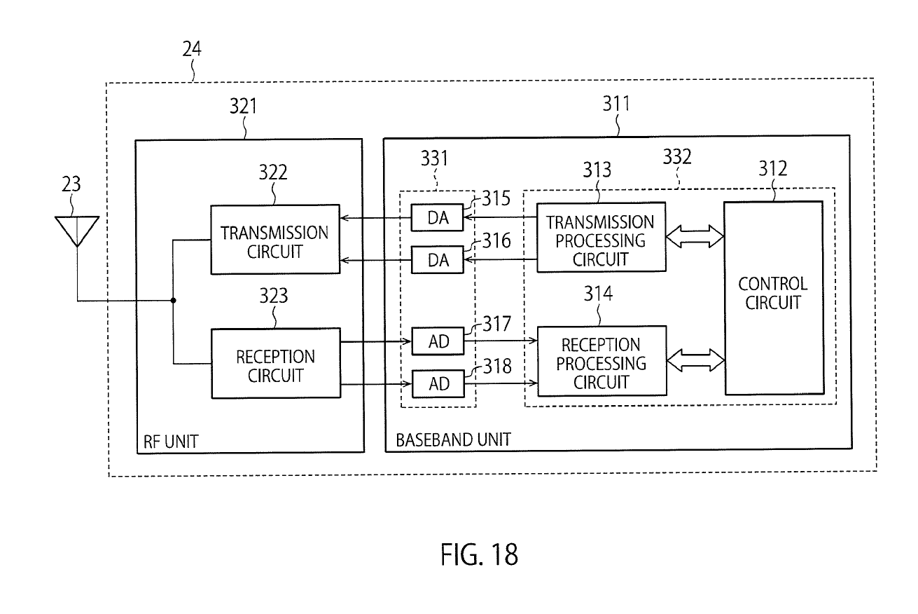

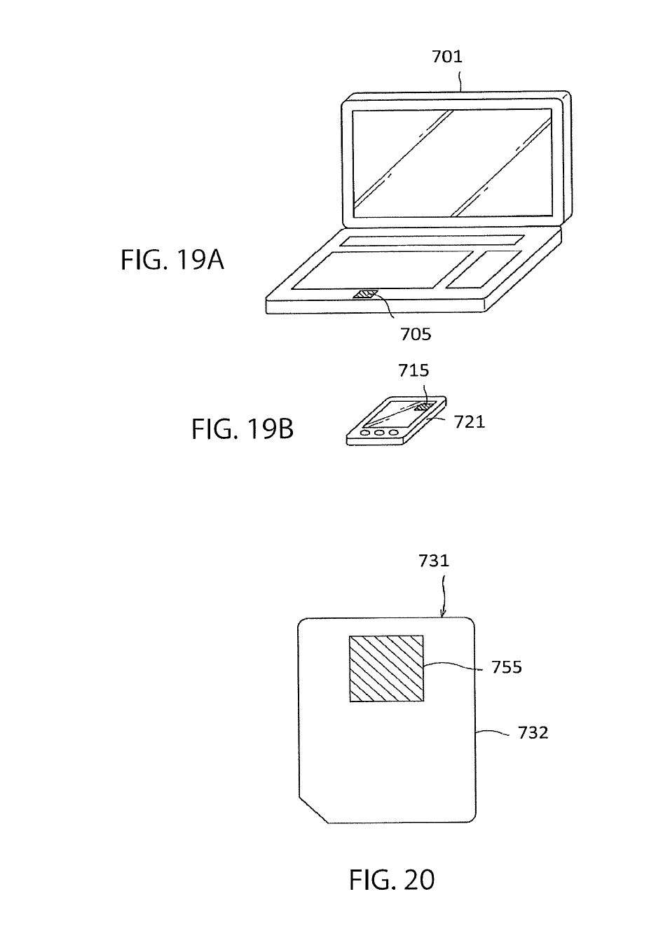

Subsequently, using FIG. 18, an example of the hardware configuration of the second communicator 24 of the hub 2 in accordance with the first embodiment is explained. FIG. 18 is a diagram that illustrates an example of the hardware configuration of the second communicator 24 of the hub 2 in accordance with the first embodiment. This hardware configuration is merely one example and various modifications may be made to the hardware configuration.

The second communicator 24 includes a baseband unit 311, an RF unit 321, and at least one antenna 23.

The baseband unit 311 includes a control circuit 312, a transmission processing circuit 313, a reception processing circuit 314, DA conversion circuits 315, 316, and AD conversion circuits 317, 318. The RF unit 321 and the baseband unit 311 may be collectively configured as one-chip IC (integrated circuit) or may be configured as independent chips.

As one example, the baseband unit 311 is a baseband LSI or a baseband IC or both of them. Alternatively, the baseband unit 311 may include an IC 332 and an IC 331 in the illustrated manner as indicated by dotted lines. In this context, components may be incorporated in a distributed manner on these ICs such that the IC 332 includes the control circuit 312, the transmission processing circuit 313, and the reception processing circuit 314 while the IC 331 includes the DA conversion circuits 315, 316 and the AD conversion circuits 317, 318. The IC 332 may be one chip IC or configured by a plurality of chip ICs.

The control circuit 312 is mainly configured to execute the functionality of the MAC (Media Access Control) layer. The functionality of the upper layer may be included in the control circuit 312. The control circuit 312 or IC 332 corresponds, for example, to a communication processing device for controlling communication or a controller for controlling communication. The wireless communicator according to the embodiment may include a transmission circuit 322 and a reception circuit 323. The wireless communicator may include further DA conversion circuits 315, 316 and the DA conversion circuits 317, 318 in addition to the transmitting circuit 322 and the receiving circuit 323. The wireless communicator may include the transmission processing circuit 313 and the reception processing circuit 314, along with the transmitting circuit 322 and the receiving circuit 323, DA conversion circuits 315, 316 and the DA conversion circuits 317, 318. The integrated circuit according to the embodiment includes a processor which performs all or a part of processing of the baseband unit 311, that is, all or a part of processing of: the control circuit 312, the transmission processing circuit 313 and the reception processing circuit 314, the DA conversion circuits 315, 316 and the DA conversion circuits 317, 318.

The transmission processing circuit 313 performs processing associated with addition of a preamble and a PHY header, encoding, modulation and generates, for example, two types of digital baseband signals (hereinafter referred to as the digital I-signal and Q-signal). In a case of MIMO transmission, two kinds of digital baseband signals are generated for each of steams.

The reception processing circuit 314 performs processing such as demodulating, decoding and analyzing of the preamble and the PHY header.

The DA conversion circuits 315 and 316 are configured to perform digital-to-analog conversion for the signals input from the transmission processing circuit 313. More specifically, the DA conversion circuit 315 converts a digital I-signal into an analog I-signal, and the DA conversion circuit 316 converts a digital Q-signal into an analog Q-signal. It should be noted that there may be a case where the signals are transmitted as single-channel signals without the quadrature modulation being performed. In this case, it suffices that one single DA conversion circuit is provided. In addition, when transmission signals of one single channel or multiple channels are transmitted in a distributed manner in accordance with the number of antennas, DA conversion circuits may be provided in the number corresponding to the number of the antennas.

The RF unit 321, by way of example, is an RF analog IC or a high-frequency wave IC. The transmitting circuit 322 in the RF unit 321 includes a transmission filter that extracts a signal of a desired bandwidth from the signal of the frame that has been subjected to the digital-to-analog conversion by the DA conversion circuits 315 and 316, a mixer that performs up-conversion for the signal that has been subjected to the filtering to the radio frequency using a signal having a predetermined frequency supplied from an oscillation device, a pre-amplifier (PA) that performs amplification for the signal that has been subjected to the up-conversion, and the like.

The receiving circuit 323 in the RF unit 321 includes an LNA (low noise amplifier) that amplifies the signal received by the antenna, a mixer that performs down-conversion of the amplified signal to the baseband using a signal having a predetermined frequency supplied from an oscillation device, a reception filter that extracts a signal of a desired bandwidth from the signal that has been subjected to the down-conversion, and the like. More specifically, the receiving circuit 323 performs quadrature demodulation for the reception signal, which has been subjected to the low noise amplification by a low noise amplifier, by carrier waves with 90 degree phase shift with respect to each other and thus generates an I-signal (In-phase signal) having the same phase as that of the reception signal and a Q-signal (Quad-phase signal) whose phase is delayed by 90 degrees with respect to the reception signal. The I-signal and the Q-signal are output from receiving circuit 323 after being subjected to the gain adjustment.

The control circuit 312 may control the operation of the transmission filter of the transmitting circuit 322 and the reception filter of the receiving circuit 323 according to the setting of a used channel. Another controller that controls the transmitting circuit 322 and the receiving circuit 323 may be provided and the same or similar control may be realized by the control circuit 312 sending instructions to that controller.

The AD conversion circuits 317, 318 in the baseband unit 311 perform analog-to-digital conversion for the input signal that is input from the receiving circuit 323. More specifically, the AD conversion circuit 317 converts the I-signal into a digital

I-signal and the AD conversion circuit 318 converts the Q-signal into a digital Q-signal. It should be noted that quadrature demodulation may not be performed and only a single-channel signal may be received. In this case, only one AD conversion circuit has to be provided. In addition, when a plurality of antennas are provided, AD conversion circuits in the number corresponding to the number of the antennas may be provided.

It should be noted that a switch may be arranged in the RF unit for switching the antenna 23 between the transmitting circuit 322 and the receiving circuit 323. By controlling the switch, the antenna 23 may be connected to the transmitting circuit 322 at the time of transmission and the antenna 23 may be connected to the receiving circuit 323 at the time of reception.

Although the DA conversion circuits 315, 316 and the AD conversion circuits 317, 318 are arranged on the side of the baseband unit 311 in FIG. 18, another configuration may be adopted where they are arranged on the side of the RF unit 321.

The configuration of FIG. 18 is one example and the present embodiment is not restricted to the configuration.

Although the descriptions of the individual embodiments are provided on the premise that the first communication scheme and the second communication scheme are different from each other, these communications schemes may be one and the same scheme.

### Sixth Embodiment

FIGS. 17(A) and 17(B) are perspective views of a wireless communication terminal in accordance with the sixth embodiment. The wireless communication terminal of FIG. 17(A) is a laptop PC 701 and the wireless communication terminal of FIG. 17(B) is a mobile terminal 721. They correspond, respectively, to one form of the terminal (which may operate as either the base station or the slave station). The laptop PC 701 and the mobile terminal 721 incorporate the wireless communication devices 705, 715, respectively. The wireless communication devices that are previously described may be used as the wireless communication devices 705, 715. The wireless communication terminal incorporating the wireless communication device is not limited to the laptop PC or the mobile terminal. For example, the wireless communication device may be incorporated in a television, digital camera, wearable device, tablet, smartphone, a gaming device, a network storage device, a monitor, a digital audio player, a web camera, a video camera, a projector, a navigation system, an external adapter, an internal adapter, a set top box, a gateway, a printer server, a mobile access point, a router, an enterprise/service provider access point, a portable device, a handheld device and so on.

In addition, the wireless communication device can be incorporated in a memory card. FIG. 18 illustrates an example where the wireless communication device is incorporated in the memory card. The memory card 731 includes a wireless communication device 755 and a memory card body case 732. The memory card 731 uses the wireless communication device 735 for wireless communications with external devices. It should be noted that the illustration of the other elements in the memory card 731 (e.g., memory, etc.) is omitted in FIG. 18.

### Seventh Embodiment

The seventh embodiment includes a bus, a processor, and an external interface in addition to the configuration of the wireless communication device in accordance with any one of the first to sixth embodiments. The processor and the external interface are connected via the bus to the buffer. The firmware runs on the processor. In this manner, by providing a configuration where the firmware is included in the wireless communication device, it is made possible to readily modify the functionality of the wireless communication device by re-writing of the firmware. The processor operating the firmware may be a processor which performs processing of a communication controlling device or a controller according to the embodiment or may be another processor which performs processing of extended function of the processing or modification of the processing. The processor operating the firmware may be incorporated into a hub or a wireless terminal according to the present embodiment. The processor may be incorporated into an integrated circuit in a wireless communication device mounted in a hub or an integrated circuit in a wireless communication device mounted in a wireless terminal

### Eighth Embodiment

The eighth embodiment includes a clock generator in addition to the configuration of the wireless communication device in accordance with any one of the first to sixth embodiments. The clock generator is configured to generate a clock and output the clock on the output terminal and to the outside of the wireless communication device. In this manner, by outputting the clock generated within the wireless communication device to the outside thereof and causing the host side to operate based on the clock output to the outside, it is made possible to cause the host side and the wireless communication device side to operate in a synchronized manner.

### Ninth Embodiment

The ninth embodiment includes a power source, a power source controller, and a wireless power supply in addition to the configuration of the wireless communication device in accordance with any one of the first to sixth embodiments. The power source controller is connected to the power source and the wireless power supply, and is configured to perform control for selecting the power source from which power is supplied to the wireless communication device. In this manner, by providing a configuration where the power source is provided in the wireless communication device, it is made possible to achieve low power consumption operation accompanied by the power source control.

### Tenth Embodiment

The tenth embodiment includes a SIM card in addition to the configuration of the wireless communication device in accordance with the ninth embodiment. The SIM card is connected, for example, to the controller in the wireless communication device, etc. In this manner, by providing a configuration where the SIM card is provided in the wireless communication device, it is made possible to readily perform the authentication processing.

### Eleventh Embodiment

The eleventh embodiment includes a video compression/extension unit in addition to the configuration of the wireless communication device in accordance with the seventh embodiment. The video compression/extension unit is connected to a bus. In this manner, by configuring the video compression/extension unit included in the wireless communication device, it is made possible to readily perform transfer of the compressed video and the extension of the received compressed video.

### Twelfth Embodiment

The twelfth embodiment includes an LED unit in addition to the configuration of the wireless communication device in accordance with any one of the first to eleventh embodiments. The LED unit is connected, for example, to the controller, the transmission processing circuit, the reception processing circuit, or the control circuit, etc. in the wireless communication device. In this manner, by providing a configuration where the LED unit is provided in the wireless communication device, it is made possible to readily notify the operating state of the wireless communication device to the user.

### Thirteenth Embodiment

The thirteenth embodiment includes a vibrator unit in addition to the configuration of the wireless communication device in accordance with any one of the first to sixth embodiments. The vibrator unit is connected, for example, to the controller, the transmission processing circuit, the reception processing circuit, or the control circuit, etc. in the wireless communication device. In this manner, by providing a configuration in which the vibrator unit is provided in the wireless communication device, it is made possible to readily notify the operating state of the wireless communication device to the user.

### Fourteenth Embodiment

In a fourteenth embodiment, the configuration of the wireless communication device includes a display in addition to the configuration of the wireless communication device according to any one of the first to sixth embodiments. The display may be connected to any block element in the wireless communication device via a bus (not shown); an access controller or a baseband IC, etc. As seen from the above, the configuration including the display to display the operation state of the wireless communication device on the display allows the operation status of the wireless communication device to be easily notified to a user.

The terms used in each embodiment should be interpreted broadly. For example, the term “processor” may encompass a general purpose processor, a central processing unit (CPU), a microprocessor, a digital signal processor (DSP), a controller, a microcontroller, a state machine, and so on. According to circumstances, a “processor” may refer to an application specific integrated circuit (ASIC), a field programmable gate array (FPGA), and a programmable logic device (PLD), etc. The term “processor” may refer to a combination of processing devices such as a plurality of microprocessors, a combination of a DSP and a microprocessor, or one or more microprocessors in conjunction with a DSP core.

As another example, the term “memory” may encompass any electronic component which can store electronic information. The “memory” may refer to various types of media such as a random access memory (RAM), a read-only memory (ROM), a programmable read-only memory (PROM), an erasable programmable read only memory (EPROM), an electrically erasable PROM (EEPROM), a non-volatile random access memory (NVRAM), a flash memory, and a magnetic or optical data storage, which are readable by a processor. It can be said that the memory electronically communicates with a processor if the processor read and/or write information for the memory. The memory may be arranged within a processor and also in this case, it can be said that the memory electronically communication with the processor.

The above-described various processes or wireless communication methods based on these processes associated with the hub 1, the node 2, or the auxiliary terminal (3, 3c) in accordance with the individual embodiments may be carried out by recording a program for executing the individual processes of the hub 1, the node 2, or the auxiliary terminal (3, 3c) in accordance with the individual embodiments in a computer-readable storage medium, reading the program recorded in the storage medium into a computer system, and executing the program by a processor.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A wireless communication device comprising:
a first communicator configured to receive a first identification information when a distance from a first communication device becomes a first distance or shorter, the first identification information identifying another communication device; and
a second communicator configured to receive a second identification information, the second identification information identifying the other communication device;
wherein the second communicator is configured to transmit a wireless signal in response to a result of comparison of the first identification information and the second identification information, the wireless signal being transmitted for connecting to a wireless network formed by either one of the device itself and the other communication device.

2. The wireless communication device according to claim 1, wherein the first communicator is configured to receive position direction information in addition to the first identification information, the position direction information including a position and/or a direction of at least either one of the other communication device and the device itself.

3. The wireless communication device according to claim 1, wherein the first communicator is configured to receive time information in addition to the first identification information, the time information being internally managed by the other communication device.

4. The wireless communication device according to claim 1, wherein
the first communicator is configured to receive frequency channel identification information in addition to the first identification information, the frequency channel identification information identifying a frequency channel used by the other communication device for communication; and
the second communicator is configured to receive the second identification information using the frequency channel indicated by the frequency channel identification information received by the first communicator.

5. The wireless communication device according to claim 1, wherein
the first communicator is configured to receive frequency channel identification information, the frequency channel identification information identifying a frequency channel determined by the first communication device; and
the second communicator is configured to receive the second identification information using the frequency channel indicated by the frequency channel identification information received by the first communicator.

6. The wireless communication device according to claim 1, wherein
the first communicator is configured to transmit device identification information when the distance from the first communication device becomes the first distance or shorter, the device identification information identifying the first communicator, and configured to receive the first identification information.

7. The wireless communication device according to claim 1, wherein
the first communicator uses a first communication scheme in the wireless reception; and
the second communicator uses a second communication scheme in the wireless reception, the second communication scheme being different from the first communication scheme.

8. The wireless communication device according to claim 1, wherein the second communicator is configured to wirelessly transmit a wireless signal to the other communication device when the first identification information and the second identification information are identical to each other, the wireless signal being transmitted for establishing a connection to the wireless network.

9. The wireless communication device according to claim 1, wherein the second communicator is activated in response to the first identification information being received by the first communicator.

10. The wireless communication device according to claim 1, wherein the wireless signal is a connection request signal requesting a connection to the wireless network when the other communication device is a hub and the device itself is a node.

11. The wireless communication device according to claim 1, wherein the wireless signal is a communication permission signal permitting a connection to the wireless network when the other communication device is a node and the device itself is a hub.

12. The wireless communication device according to claim 1, comprising:
at least one first antenna; and
at least one second antenna
wherein the first communicator is configured to use the first antenna and the second communicator is configured to use the second antenna.

13. An wireless communication device comprising:
a first communicator configured to transmit a first identification information when a distance from a first communication device becomes a first distance or shorter, first identification information identifying the device itself; and
a second communicator configured to transmit a second identification information, the second identification information identifying the device itself; and
the second communicator is configured to start communication associated with a connection to a wireless network formed by either one of the device itself and another communication device in response to a wireless signal having been received by the second communicator, the wireless signal being a signal for establishing the connection to the wireless network.

14. The wireless communication device according to claim 13, wherein the first communicator is configured to transmit position direction information in addition to the first identification information, the position direction information including a position and/or a direction of at least either one of the first communicator and the second communicator.

15. The wireless communication device according to claim 13, wherein the first communicator is configured to transmit time information in addition to the first identification information, the time information being internally managed by the device itself.

16. The wireless communication device according to according to claim 13, wherein the first communicator is configured to transmit frequency channel identification information in addition to the first identification information, the frequency channel identification information identifying a frequency channel used by the second communicator for wireless communication of the second identification information.

17. The wireless communication device according to claim 13, wherein the first communicator is configured to receive frequency channel identification information, the frequency channel identification information identifying a frequency channel determined by the first communication device; and
the second communicator is configured to transmit the second identification information using the frequency channel indicated by the frequency channel identification information.

18. The wireless communication device according to claim 13, wherein the first communicator is configured to transmit device identification information when the distance from the first communication device becomes the first distance or shorter the device identification information identifying the first communicator.

19. The wireless communication device according to claim 13, comprising:
at least one first antenna; and
at least one second antenna
wherein the first communicator is configured to use the first antenna and the second communicator is configured to use the second antenna.

20. A wireless communication method comprising:
receiving a first identification information in a first communication scheme when a distance from a first communication device becomes a first distance or shorter, the first identification information identifying another communication device; and
receiving a second identification information in a second communication scheme, the second identification information identifying the other communication device;
transmitting a wireless signal in response to a result of comparison of the first identification information and the second identification information, the wireless signal being transmitted for connecting to a wireless network formed by either one of the device itself and the other communication device.
